(19) United States
(12) Patent Application Publication
(10) Pub. No.: US 2025/0386350 A1
(43) Pub. Date: Dec. 18, 2025

(54) TECHNIQUES FOR UPLINK RESOURCE MUTING AT WIRELESS DEVICES

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Yan ZHOU, San Diego, CA (US)

(21) Appl. No.: 19/227,271

(22) Filed: Jun. 3, 2025

Related U.S. Application Data
(60) Provisional application No. 63/660,092, filed on Jun. 14, 2024.

(51) Int. Cl. H04W 72/21; H04L 5/14; H04L 27/26

(52) U.S. Cl. CPC H04W 72/21; H04L 5/14; H04L 27/2636; H04L 27/2678

(57) ABSTRACT

Methods, systems, and devices for wireless communications are described. A user equipment (UE) may transmit a capability message indicating that the UE supports uplink resource muting in accordance with one or more resource muting patterns on a per uplink waveform basis. In some examples, each of the one or more resource muting patterns may be associated with a respective set of resource elements. In some examples, the respective set of resource elements may be associated with a cross-link interference (CLI) measurement, and uplink transmissions on the respective set of resource elements may muted during the CLI measurement. The UE may receive an indication to operate in accordance with a resource muting pattern of the one or more resource muting patterns based on transmission of the at least one capability message. As such, the UE may communicate in accordance with the resource muting pattern based on reception of the indication.

### CROSS REFERENCE

The present application for patent claims the benefit of U.S. Provisional Patent Application No. 63/660,092 by ZHANG et al., entitled “TECHNIQUES FOR UPLINK RESOURCE MUTING AT WIRELESS DEVICES,” filed Jun. 14, 2024, assigned to the assignee hereof, and expressly incorporated by reference herein.

### FIELD OF TECHNOLOGY

The following relates to wireless communications, including techniques for uplink resource muting at wireless devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting at least one capability message indicating that the UE supports uplink resource muting in accordance with one or more resource muting patterns, where each resource muting pattern of the one or more resource muting patterns is associated with a respective set of resource elements, receiving an indication to operate in accordance with a resource muting pattern of the one or more resource muting patterns based on transmission of the at least one capability message, and communicating in accordance with the resource muting pattern based on reception of the indication.

A UE for wireless communications is described. The UE may include one or more memories storing processor executable code, and one or more processors coupled with the one or more memories. The one or more processors may individually or collectively be operable to execute the code to cause the UE to transmit at least one capability message indicating that the UE supports uplink resource muting in accordance with one or more resource muting patterns, where each resource muting pattern of the one or more resource muting patterns is associated with a respective set of resource elements, receive an indication to operate in accordance with a resource muting pattern of the one or more resource muting patterns based on transmission of the at least one capability message, and communicate in accordance with the resource muting pattern based on reception of the indication.

Another UE for wireless communications is described. The UE may include means for transmitting at least one capability message indicating that the UE supports uplink resource muting in accordance with one or more resource muting patterns, where each resource muting pattern of the one or more resource muting patterns is associated with a respective set of resource elements, means for receiving an indication to operate in accordance with a resource muting pattern of the one or more resource muting patterns based on transmission of the at least one capability message, and means for communicating in accordance with the resource muting pattern based on reception of the indication.

A non-transitory computer-readable medium storing code for wireless communications is described. The code may include instructions executable by one or more processors to transmit at least one capability message indicating that the UE supports uplink resource muting in accordance with one or more resource muting patterns, where each resource muting pattern of the one or more resource muting patterns is associated with a respective set of resource elements, receive an indication to operate in accordance with a resource muting pattern of the one or more resource muting patterns based on transmission of the at least one capability message, and communicate in accordance with the resource muting pattern based on reception of the indication.

In some examples of the method, UEs, and non-transitory computer-readable medium described herein, the at least one capability message indicates that the uplink resource muting may be supported by the UE in accordance with the one or more resource muting patterns on a per uplink waveform type basis.

In some examples of the method, UEs, and non-transitory computer-readable medium described herein, each resource muting pattern of the one or more resource muting patterns may be rate matched in accordance with a set of muted resource elements corresponding to each resource muting pattern.

In some examples of the method, UEs, and non-transitory computer-readable medium described herein, the one or more resource muting patterns include at least one of a first resource muting pattern based on a comb-2 sounding reference signal (SRS) muting pattern; a second muting pattern based on a zero power phase tracking reference signal (PTRS) resource muting pattern or a sparse in frequency resource muting pattern; a third muting pattern based on a comb-2 SRS muting pattern for discrete Fourier Transform-spread orthogonal frequency division multiplexing (DFT-S-OFDM), for cyclic prefix orthogonal frequency division multiplexing (CP-OFDM), or both; or a fourth muting pattern based on a zero power PTRS resource muting pattern or a sparse in frequency resource muting pattern, the fourth muting pattern for DFT-S-OFDM, for CP-OFDM, or both.

Some examples of the method, UEs, and non-transitory computer-readable medium described herein may further include operations, features, means, or instructions for transmitting, as part of the at least one capability message, an indication of a maximum quantity of uplink resource muting patterns supported by the UE, an indication of a respective maximum quantity of uplink resource muting patterns supported by the UE for each bandwidth part (BWP) of a set of BWPs, an indication of a respective maximum quantity of uplink resource muting patterns supported by the UE for each waveform of a set of waveforms, or a combination thereof.

In some examples of the method, UEs, and non-transitory computer-readable medium described herein, transmitting the at least one capability message may include operations, features, means, or instructions for transmitting an indication that the UE supports the uplink resource muting for a radio resource control (RRC) connected mode, for an RRC inactive mode, for an RRC idle mode, or a combination thereof.

Some examples of the method, UEs, and non-transitory computer-readable medium described herein may further include operations, features, means, or instructions for communicating in accordance with the resource muting pattern may be further based on one or more symbols being subband full duplex (SBFD) symbols or full duplex symbols.

In some examples of the method, UEs, and non-transitory computer-readable medium described herein, a first set of muted resource elements associated with the resource muting pattern at least partially overlaps with a second set of resource elements scheduled for a demodulation reference signal (DMRS).

In some examples of the method, UEs, and non-transitory computer-readable medium described herein, communicating in accordance with the resource muting pattern may include operations, features, means, or instructions for dropping the DMRS based on the first set of muted resource elements at least partially overlapping with the second set of resource elements scheduled for the DMRS and muting the first set of muted resource elements based on dropping the DMRS.

In some examples of the method, UEs, and non-transitory computer-readable medium described herein, communicating in accordance with the resource muting pattern may include operations, features, means, or instructions for transmitting the DMRS and an associated uplink data message, where the UE refrains from muting the first set of muted resource elements based on the first set of muted resource elements at least partially overlapping with the second set of resource elements scheduled for the DMRS.

In some examples of the method, UEs, and non-transitory computer-readable medium described herein, communicating in accordance with the resource muting pattern may include operations, features, means, or instructions for transmitting, via a subset of the second set of resource elements, the DMRS and an associated uplink data message, where the subset of the second set of resource elements includes one or more resource elements that do not overlap with the first set of muted resource elements and muting a subset of the first set of muted resource elements that do not overlap with the second set of resource elements.

In some examples of the method, UEs, and non-transitory computer-readable medium described herein, the UE determines an error case based on a subset of the second set of resource elements overlapping in a same symbol with a subset of the first set of muted resource elements.

In some examples of the method, UEs, and non-transitory computer-readable medium described herein, the UE determines an error case based on a subset of the second set of resource elements overlapping in a same symbol and a same frequency carrier with a subset of the first set of muted resource elements.

Some examples of the method, UEs, and non-transitory computer-readable medium described herein may further include operations, features, means, or instructions for determining, as part of a transport block size calculation, a quantity of resource blocks associated with a cross-link interference (CLI) measurement, where the quantity of resource blocks may be equal to an allocated quantity of resource blocks scheduled during the CLI measurement.

Some examples of the method, UEs, and non-transitory computer-readable medium described herein may further include operations, features, means, or instructions for determining, as part of a transport block size calculation, a quantity of resource blocks associated with a CLI measurement, where the quantity of resource blocks may be equal to an allocated quantity of resource blocks scheduled during the CLI measurement that do not overlap with a first set of muted resource elements.

In some examples of the method, UEs, and non-transitory computer-readable medium described herein, a first set of muted resource elements associated with the resource muting pattern at least partially overlaps with a second set of resource elements scheduled for a PTRS.

In some examples of the method, UEs, and non-transitory computer-readable medium described herein, communicating in accordance with the resource muting pattern may include operations, features, means, or instructions for transmitting the PTRS via a subset of the second set of resource elements, where the subset of the second set of resource elements includes one or more resource elements that do not overlap with the first set of muted resource elements and muting a subset of the first set of muted resource elements that do not overlap with the second set of resource elements.

In some examples of the method, UEs, and non-transitory computer-readable medium described herein, communicating in accordance with the resource muting pattern may include operations, features, means, or instructions for transmitting the PTRS via the second set of resource elements, where the UE refrains from muting the first set of muted resource elements based on the first set of muted resource elements at least partially overlapping with the second set of resource elements scheduled for the PTRS.

In some examples of the method, UEs, and non-transitory computer-readable medium described herein, the UE determines an error case based on a subset of the second set of resource elements overlapping in a same symbol with a subset of the first set of muted resource elements.

In some examples of the method, UEs, and non-transitory computer-readable medium described herein, the UE determines an error case based on a subset of the second set of resource elements overlapping in a same symbol and a same frequency carrier with a subset of the first set of muted resource elements.

In some examples of the method, UEs, and non-transitory computer-readable medium described herein, a first set of muted resource elements associated with the resource muting pattern at least partially overlaps with a second set of resource elements scheduled for uplink control information (UCI).

In some examples of the method, UEs, and non-transitory computer-readable medium described herein, the UE determines an error case based on a subset of the second set of resource elements overlapping in a same orthogonal frequency-division multiplexing (OFDM) symbol with a subset of the first set of muted resource elements.

In some examples of the method, UEs, and non-transitory computer-readable medium described herein, the UE determines an error case based on a subset of the second set of resource elements that overlap in a same symbol and a same frequency carrier with a subset of the first set of muted resource elements.

In some examples of the method, UEs, and non-transitory computer-readable medium described herein, the UE determines an error case in accordance with UCI overlapping with a physical uplink shared channel (PUSCH) in a same OFDM symbol based on the PUSCH being allocated with less than a threshold quantity of resource blocks, being allocated with less than a threshold quantity of symbols, or both.

In some examples of the method, UEs, and non-transitory computer-readable medium described herein, a first set of muted resource elements associated with the resource muting pattern at least partially overlaps with a second set of resource elements scheduled for an PUSCH message.

Some examples of the method, UEs, and non-transitory computer-readable medium described herein may further include operations, features, means, or instructions for transmitting the PUSCH message based on the PUSCH message being allocated with less than a threshold quantity of resource blocks, being allocated with less than a threshold quantity of symbols, or both, where the UE refrains from muting the first set of muted resource elements.

Some examples of the method, UEs, and non-transitory computer-readable medium described herein may further include operations, features, means, or instructions for receiving a first control message that configures the UE with the one or more resource muting patterns and receiving a second control message that includes one or more bits that indicates activation or deactivation of the resource muting pattern, where the indication to operate in accordance with the resource muting pattern may be based on the one or more bits.

In some examples of the method, UEs, and non-transitory computer-readable medium described herein, the first control message configures the UE with a set of multiple resource muting patterns; and the second control message includes a set of multiple bits, a first value of the set of multiple bits indicates deactivation for each of the set of multiple resource muting patterns and one or more second values of the set of multiple bits respectively indicate activation of a respective resource muting pattern of the set of multiple resource muting patterns.

In some examples of the method, UEs, and non-transitory computer-readable medium described herein, the second control message may be a medium access control-control element (MAC-CE) message.

In some examples of the method, UEs, and non-transitory computer-readable medium described herein, the second control message may be a group-common downlink control information (GC-DCI) message.

In some examples of the method, UEs, and non-transitory computer-readable medium described herein, the second control message may be a downlink control information (DCI) message and the one or more bits may be included in a field of the DCI message.

In some examples of the method, UEs, and non-transitory computer-readable medium described herein, the respective set of resource elements may be at least in part associated with a CLI measurement and uplink transmissions on the respective set of resource elements may be muted during the CLI measurement.

A method for wireless communications by a network entity is described. The method may include receiving at least one capability message indicating that a UE supports uplink resource muting in accordance with one or more resource muting patterns, where each resource muting pattern of the one or more resource muting patterns is associated with a respective set of resource elements, transmitting an indication for the UE to operate in accordance with a resource muting pattern of the one or more resource muting patterns based on transmission of the at least one capability message, and communicating, with the UE, in accordance with the resource muting pattern based on transmission of the indication.

A network entity for wireless communications is described. The network entity may include one or more memories storing processor executable code, and one or more processors coupled with the one or more memories. The one or more processors may individually or collectively be operable to execute the code to cause the network entity to receive at least one capability message indicating that a UE supports uplink resource muting in accordance with one or more resource muting patterns, where each resource muting pattern of the one or more resource muting patterns is associated with a respective set of resource elements, transmit an indication for the UE to operate in accordance with a resource muting pattern of the one or more resource muting patterns based on transmission of the at least one capability message, and communicate, with the UE, in accordance with the resource muting pattern based on transmission of the indication.

Another network entity for wireless communications is described. The network entity may include means for receiving at least one capability message indicating that a UE supports uplink resource muting in accordance with one or more resource muting patterns, where each resource muting pattern of the one or more resource muting patterns is associated with a respective set of resource elements, means for transmitting an indication for the UE to operate in accordance with a resource muting pattern of the one or more resource muting patterns based on transmission of the at least one capability message, and means for communicating, with the UE, in accordance with the resource muting pattern based on transmission of the indication.

A non-transitory computer-readable medium storing code for wireless communications is described. The code may include instructions executable by one or more processors to receive at least one capability message indicating that a UE supports uplink resource muting in accordance with one or more resource muting patterns, where each resource muting pattern of the one or more resource muting patterns is associated with a respective set of resource elements, transmit an indication for the UE to operate in accordance with a resource muting pattern of the one or more resource muting patterns based on transmission of the at least one capability message, and communicate, with the UE, in accordance with the resource muting pattern based on transmission of the indication.

In some examples of the method, network entities, and non-transitory computer-readable medium described herein, the at least one capability message indicates that the uplink resource muting may be supported by the UE in accordance with the one or more resource muting patterns on a per uplink waveform type basis.

In some examples of the method, network entities, and non-transitory computer-readable medium described herein, each resource muting pattern of the one or more resource muting patterns may be rate matched in accordance with a set of muted resource elements corresponding to each resource muting pattern.

In some examples of the method, network entities, and non-transitory computer-readable medium described herein, the one or more resource muting patterns include at least one of a first resource muting pattern based on a comb-2 SRS muting pattern; a second muting pattern based on a zero power PTRS resource muting pattern or a sparse in frequency resource muting pattern; a third muting pattern based on a comb-2 SRS muting pattern for DFT-S-OFDM, for CP-OFDM, or both; or a fourth muting pattern based on a zero power PTRS resource muting pattern or a sparse in frequency resource muting pattern, the fourth muting pattern for DFT-S-OFDM, for CP-OFDM, or both.

Some examples of the method, network entities, and non-transitory computer-readable medium described herein may further include operations, features, means, or instructions for receiving, as part of the at least one capability message, an indication of a maximum quantity of uplink resource muting patterns supported by the UE, an indication of a respective maximum quantity of uplink resource muting patterns supported by the UE for each BWP of a set of BWPs, an indication of a respective maximum quantity of uplink resource muting patterns supported by the UE for each waveform of a set of waveforms, or a combination thereof.

In some examples of the method, network entities, and non-transitory computer-readable medium described herein, receiving the at least one capability message may include operations, features, means, or instructions for receiving an indication that the UE supports the uplink resource muting for an RRC connected mode, for an RRC inactive mode, for an RRC idle mode, or a combination thereof.

In some examples of the method, network entities, and non-transitory computer-readable medium described herein, a first set of muted resource elements associated with the resource muting pattern at least partially overlaps with a second set of resource elements scheduled for a DMRS.

In some examples of the method, network entities, and non-transitory computer-readable medium described herein, communicating in accordance with the resource muting pattern may include operations, features, means, or instructions for receiving the DMRS and an associated uplink data message, where the UE refrains from muting the first set of muted resource elements based on the first set of muted resource elements at least partially overlapping with the second set of resource elements scheduled for the DMRS.

In some examples of the method, network entities, and non-transitory computer-readable medium described herein, communicating in accordance with the resource muting pattern may include operations, features, means, or instructions for receiving, via a subset of the second set of resource elements, the DMRS and an associated uplink data message, where the subset of the second set of resource elements include one or more resource elements that do not overlap with the first set of muted resource elements.

In some examples of the method, network entities, and non-transitory computer-readable medium described herein, network entity does not schedule a subset of the second set of resource elements that overlap with a subset of the first set of muted resource elements.

In some examples of the method, network entities, and non-transitory computer-readable medium described herein, network entity does not schedule a subset of the second set of resource elements that overlap in a same symbol with a subset of the first set of muted resource elements.

In some examples of the method, network entities, and non-transitory computer-readable medium described herein, network entity does not schedule a subset of the second set of resource elements that overlap in a same symbol and a same frequency carrier with a subset of the first set of muted resource elements.

In some examples of the method, network entities, and non-transitory computer-readable medium described herein, a first set of muted resource elements associated with the resource muting pattern at least partially overlaps with a second set of resource elements scheduled for a PTRS.

In some examples of the method, network entities, and non-transitory computer-readable medium described herein, communicating in accordance with the resource muting pattern may include operations, features, means, or instructions for receiving the PTRS, via a subset of the second set of resource elements, where the subset of the second set of resource elements include one or more resource elements that do not overlap with the first set of muted resource elements.

In some examples of the method, network entities, and non-transitory computer-readable medium described herein, communicating in accordance with the resource muting pattern may include operations, features, means, or instructions for receiving the PTRS, via the second set of resource elements, where the UE refrains from muting the first set of muted resource elements based on the first set of muted resource elements at least partially overlapping with the second set of resource elements scheduled for the PTRS.

In some examples of the method, network entities, and non-transitory computer-readable medium described herein, network entity does not schedule a subset of the second set of resource elements that overlap with a subset of the first set of muted resource elements.

In some examples of the method, network entities, and non-transitory computer-readable medium described herein, network entity does not schedule a subset of the second set of resource elements that overlap in a same OFDM symbol with a subset of the first set of muted resource elements.

In some examples of the method, network entities, and non-transitory computer-readable medium described herein, network entity does not schedule a subset of the second set of resource elements that overlap in a same symbol and a same frequency carrier with a subset of the first set of muted resource elements.

In some examples of the method, network entities, and non-transitory computer-readable medium described herein, a first set of muted resource elements associated with the resource muting pattern at least partially overlaps with a second set of resource elements scheduled for UCI.

In some examples of the method, network entities, and non-transitory computer-readable medium described herein, network entity does not schedule a subset of the second set of resource elements that overlap with a subset of the first set of muted resource elements.

In some examples of the method, network entities, and non-transitory computer-readable medium described herein, network entity does not schedule a subset of the second set of resource elements that overlap in a same OFDM symbol with a subset of the first set of muted resource elements.

In some examples of the method, network entities, and non-transitory computer-readable medium described herein, network entity does not schedule a subset of the second set of resource elements that overlap in a same symbol and a same frequency carrier with a subset of the first set of muted resource elements.

In some examples of the method, network entities, and non-transitory computer-readable medium described herein, the network entity does not schedule UCI that overlaps with an PUSCH in a same OFDM symbol based on the PUSCH being allocated with less than a threshold quantity of resource blocks, being allocated with less than a threshold quantity of symbols, or both.

In some examples of the method, network entities, and non-transitory computer-readable medium described herein, a first set of muted resource elements associated with the resource muting pattern at least partially overlaps with a second set of resource elements scheduled for an PUSCH message.

Some examples of the method, network entities, and non-transitory computer-readable medium described herein may further include operations, features, means, or instructions for receiving the PUSCH message without the first set of muted resource elements being muted based on the PUSCH message being allocated with less than a threshold quantity of resource blocks, being allocated with less than a threshold quantity of symbols, or both.

Some examples of the method, network entities, and non-transitory computer-readable medium described herein may further include operations, features, means, or instructions for transmitting a first control message that configures the UE with the one or more resource muting patterns and transmitting a second control message that includes one or more bits that indicates activation of the resource muting pattern, where the indication to operate in accordance with the resource muting pattern may be based on the one or more bits.

In some examples of the method, network entities, and non-transitory computer-readable medium described herein, the first control message configures the UE with a single resource muting pattern; and the second control message includes a single bit, a first value of the single bit indicates the activation of the single resource muting pattern and a second value of the single bit indicates deactivation of the single resource muting pattern.

In some examples of the method, network entities, and non-transitory computer-readable medium described herein, the first control message configures the UE with a set of multiple resource muting patterns; and the second control message includes a set of multiple bits, a first value of the set of multiple bits indicates deactivation for each of the set of multiple resource muting patterns and one or more second values of the set of multiple bits respectively indicate activation of a respective resource muting pattern of the set of multiple resource muting patterns.

In some examples of the method, network entities, and non-transitory computer-readable medium described herein, the second control message may be a MAC-CE message.

In some examples of the method, network entities, and non-transitory computer-readable medium described herein, the second control message may be a GC-DCI message.

In some examples of the method, network entities, and non-transitory computer-readable medium described herein, the second control message may be a dynamic DCI message and the one or more bits may be included in a field of the dynamic DCI message.

In some examples of the method, network entities, and non-transitory computer-readable medium described herein, the respective set of resource elements may be at least in part associated with a CLI measurement and uplink transmissions on the respective set of resource elements may be muted during the CLI measurement.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for uplink resource muting at wireless devices in accordance with one or more aspects of the present disclosure.

FIG. 2 shows an example of a wireless communications system that supports techniques for uplink resource muting at wireless devices in accordance with one or more aspects of the present disclosure.

FIG. 3 shows an example of a muting pattern operation scheme that supports techniques for uplink resource muting at wireless devices in accordance with one or more aspects of the present disclosure.

FIG. 4 shows an example of a process flow that supports techniques for uplink resource muting at wireless devices in accordance with one or more aspects of the present disclosure.

FIGS. 5 and 6 show block diagrams of devices that support techniques for uplink resource muting at wireless devices in accordance with one or more aspects of the present disclosure.

FIG. 7 shows a block diagram of a communications manager that supports techniques for uplink resource muting at wireless devices in accordance with one or more aspects of the present disclosure.

FIG. 8 shows a diagram of a system including a device that supports techniques for uplink resource muting at wireless devices in accordance with one or more aspects of the present disclosure.

FIGS. 9 and 10 show block diagrams of devices that support techniques for uplink resource muting at wireless devices in accordance with one or more aspects of the present disclosure.

FIG. 11 shows a block diagram of a communications manager that supports techniques for uplink resource muting at wireless devices in accordance with one or more aspects of the present disclosure.

FIG. 12 shows a diagram of a system including a device that supports techniques for uplink resource muting at wireless devices in accordance with one or more aspects of the present disclosure.

FIGS. 13 and 14 show flowcharts illustrating methods that support techniques for uplink resource muting at wireless devices in accordance with one or more aspects of the present disclosure.

### DETAILED DESCRIPTION

In some examples of wireless communications one or more network entities may perform cross-link interference (CLI) measurements. For example, network entity to network entity co-channel CLI measurements may include a first network entity measuring a wireless interference impact from a second network entity that operates in a same carrier bandwidth. As such, the first network entity may schedule one or more resource elements, over which the first network entity may perform the CLI measurements. In some examples, the first network entity may be servicing one or more user equipments (UEs), which may transmit wireless messages to the first network entity via respective uplinks. As such, it may be advantageous for the first network entity to mute one or more uplink resource elements while performing CLI measurements to reduce interference from uplink transmissions. For example, the network entity may indicate to the UE to refrain from performing uplink transmissions over one or more resource elements that the network entity has allocated for CLI measurements. In some examples, the uplink resource muting may be associated with a muting pattern that the network entity may indicate to the UE.

In some cases, however, respective UEs may be unable to support one or more different uplink resource muting patterns. Additionally, or alternatively, a given uplink resource muting pattern may overlap with one or more scheduled uplink transmissions (e.g., a demodulated reference signal (DMRS), a phase tracking reference signal (PTRS), an uplink control information (UCI) message, or a physical uplink shared channel (PUSCH) message). Such overlap between an uplink resource muting pattern and scheduled uplink messages may result in the UE dropping uplink messages, decreasing the efficiency of wireless communications. Additionally, or alternatively, applying an uplink resource pattern may change power allocation in symbols that include muted resource elements which may result in phase discontinuity between respective symbols. Additionally, or alternatively, muted resource elements may change a determined transport block size for a given transmission which may result in miscommunication between a receiving wireless device and a transmitting wireless device.

As such, a network entity and a UE may operate in accordance with an uplink resource muting procedure to increase the efficacy of the UE using an uplink resource muting pattern during CLI measurement occasions performed by the network entity. In this regard, uplink resource muting procedures described herein may enable the UE to operate in accordance with a resource muting pattern (to enable CLI measurement at the network entity), while also enabling the UE (and the network entity) to resolve conflicts between muted uplink resources and other communications, thereby improving coordination between the devices. For example, as part of the uplink resource muting procedure, the UE may transmit one or more muting capability messages to the network entity, where the one or more muting capability messages indicate UE support for uplink resource muting in accordance with one or more uplink resource muting patterns. In some examples, the one or more muting capability messages may indicate one or more of different uplink resource muting patterns supported by the UE, one or more waveform types the UE supports for the different uplink resource muting patterns, a maximum uplink resource muting pattern the UE supports, and which radio resource control (RRC) modes the UE supports uplink resource muting patterns for. Additionally, or alternatively, the UE and the network entity may define one or more collision resolution protocols to determine how to handle resource elements that are scheduled for an uplink message and associated with resource muting in accordance with a given uplink resource muting pattern. Additionally, or alternatively, the network entity may configure the UE with one or more uplink resource muting patterns and transmit a control message that may activate or deactivate respective uplink resource muting patterns for use at the UE.

For the purposes of the present disclosure, the term “muted resources,” “muted resource elements,” and like terms, may be used to refer to resources that have been muted (e.g., past tense), or that are configured or otherwise intended to be muted in the future (e.g., in accordance with an uplink resource muting pattern). As such, resources may be considered “muted resources” once an uplink resource muting pattern has been configured, and before any “muting” is actually performed for the respective resources.

By operating in accordance with the uplink resource muting procedure, the UE and the network entity may reduce uplink interference during CLI measurements, which may result in an increase reliability of CLI measurement communications between respective network entities. Additionally, or alternatively, the uplink resource muting procedure may define a set of protocols for the UE to follow while operating in accordance with an uplink resource muting pattern, which may reduce miscommunication and increase message reliability between the network entity and the UE.

Aspects of the disclosure are initially described in the context of wireless communications systems, a muting pattern operation scheme, and a process flow. Aspects of the disclosure are further illustrated by and described with reference to apparatus diagrams, system diagrams, and flowcharts that relate to techniques for uplink resource muting at wireless devices.

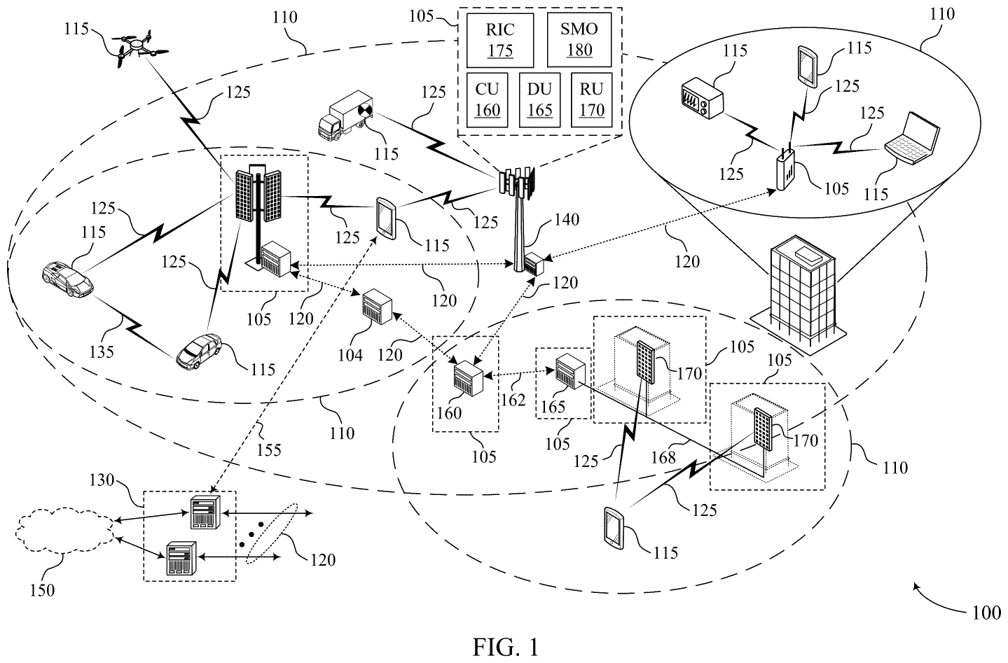

FIG. 1 shows an example of a wireless communications system 100 that supports techniques for uplink resource muting at wireless devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (CNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of wireless communications system 100 a network entity 105 and a UE 115 may operate in accordance with an uplink resource muting procedure to increase the efficacy of the UE 115 using an uplink resource muting pattern during CLI measurement occasions performed by the network entity 105. For example, as part of the uplink resource muting procedure, the UE 115 may transmit one or more muting capability messages to the network entity 105, where the one or more muting capability messages indicate UE 115 support for uplink resource muting in accordance with one or more uplink resource muting patterns. In some examples, the one or more muting capability messages may indicate one or more of different uplink resource muting patterns supported by the UE 115, one or more waveform types the UE 115 supports for the different uplink resource muting patterns, a maximum uplink resource muting pattern the UE 115 supports, and which RRC modes the UE 115 supports uplink resource muting patterns for. Additionally, or alternatively, the UE 115 and the network entity 105 may define one or more collision resolution protocols to determine how to handle resource elements that are scheduled for an uplink message and associated with resource muting in accordance with a given uplink resource muting pattern. Additionally, or alternatively, the network entity 105 may configure the UE 115 with one or more uplink resource muting patterns and transmit a control message that may activate or deactivate respective uplink resource muting patterns for use at the UE 115.

By operating in accordance with the uplink resource muting procedure, the UE 115 and the network entity 105 may reduce uplink interference during CLI measurements, which may result in an increase reliability of CLI measurement communications between respective network entities 105. Additionally, or alternatively, the uplink resource muting procedure may define a set of protocols for the UE 115 to follow while operating in accordance with an uplink resource muting pattern, which may reduce miscommunication and increase message reliability between the network entity 105 and the UE 115.

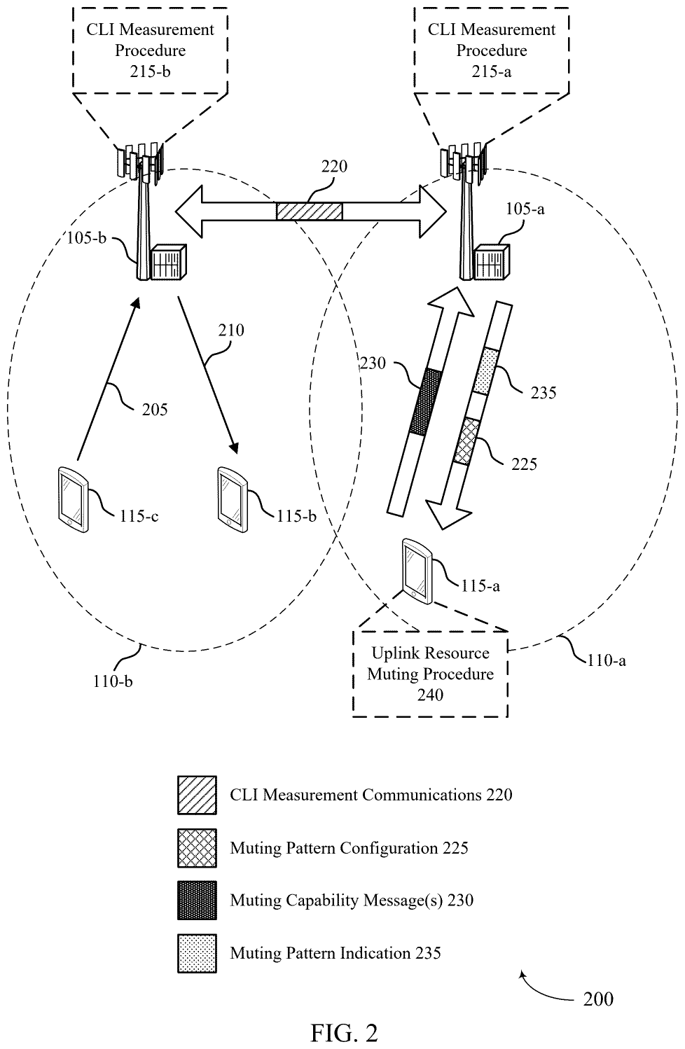

FIG. 2 shows an example of a wireless communications system 200 that supports techniques for uplink resource muting at wireless devices in accordance with one or more aspects of the present disclosure. The wireless communications system 200 may implement or may be implemented by aspects of the wireless communications system 100. For example, the wireless communications system 200 may include a UE 115-a, 115-b, and 115-c, which may be respective examples of a UE 115 as described herein. Additionally, the wireless communications system 200 may include a network entity 105-a and 105-b, which may be respective examples of a network entity 105 as described herein.

As illustrated in FIG. 2, each of network entity 105-a and 105-b may be associated with a respective geographic coverage area 110-a and 110-b, which may be respective examples of geographic coverage areas 110 as described with reference to FIG. 1. For example, the network entity 105-a may communicate with one or more UEs 115 that are within the geographic coverage area 110-a (e.g., UE 115-a) and the network entity 105-b may communicate with one or more UEs 115 that are within the geographic coverage area 110-b (e.g., the UE 115-b and 115-c). Additionally, or alternatively, each of the UEs 115 may transmit wireless communications with a respective network entity 105 using an uplink 205 and receive downlink communications with the respective network entity 105 using a downlink 210.

In some examples, the wireless devices of wireless communications system 200 may support subband full duplex (SBFD) based communications for time division duplexing (TDD) based operations, for intra-band carrier aggregation (CA) based operations, or both. For instance, SBFD based communications may allow for concurrent transmission and reception of wireless messages via uplink 205 and downlink 210 on a subband basis. Additionally, or alternatively, a full duplex operation at a network entity 105 may allow the network entity 105 to perform concurrent reception and transmission. For instance, in accordance with full duplex operation, the network entity 105-b may concurrently receive an uplink message from the UE 115-c and transmit a downlink message to the UE 115-b.

In some cases, one or more first wireless devices may experience CLI based on concurrent communications from one or more second wireless devices. For example, two or more wireless devices may experience CLI when signals from a first wireless link interfere with signals on a second wireless link, where the first and second wireless links operate in a same frequency band. For instance, the UE 115-b and 115-c may experience inter-subband intra-cell CLI if the UE 115-b and 115-c concurrently communicate with a same cell of the network entity 105-b via one or more subbands of a same frequency band. Additionally, or alternatively, the UE 115-a and 115-b may experience inter-subband inter-cell inter-UE CLI if the UE 115-a and 115-b concurrently communicate with respective cells (e.g., network entity 105-a and 105-b) via one or more subbands of a same frequency band. Additionally, or alternatively, the network entity 105-a and 105-b may experience inter-subband inter-gNB CLI, if the network entity 105-a and 105-b concurrently communicate with respective UEs 115 via one or more subbands of a same frequency band.

In some examples, to reduce CLI, one or more wireless devices may perform CLI measurements. For example, as illustrated in FIG. 2, the network entity 105-a and 105-b may respectively perform a CLI measurement procedure 215-a and 215-b. For instance, in accordance with CLI measurement procedure 215-a, the network entity 105-a may measure, over a set of resource elements, CLI relative to communications performed by the network entity 105-b over one or more subbands, one or more wireless links, or both. Additionally, or alternatively, in accordance with CLI measurement procedure 215-b, the network entity 105-b may measure, over a set of resource elements, CLI relative to communications performed by the network entity 105-a over one or more subbands, one or more wireless links, or both. In response to performing CLI measurement procedures 215-a and 215-b, the network entities 105-a and 105-b may perform CLI measurement communications 220. For example, as part of the CLI measurement communications 220, the network entity 105-a may transmit a first CLI measurement report to the network entity 105-b that includes one or more measurements generated during CLI measurement procedure 215-a, the network entity 105-b may transmit a second CLI measurement report to the network entity 105-a that includes one or more measurements generated during CLI measurement procedure 215-b, or both.

Based on the CLI measurement communications 220, the network entities 105-a and 105-b may perform one or more CLI mitigation techniques to reduce gNB-to-gNB co-channel CLI. For instance, the CLI mitigation techniques may include coordinated multipoint (COMP) communications to mitigate interference by coordinating transmissions between multiple network cells. Additionally, or alternatively, the network entities 105-a and 105-b may dynamically allocate spectrum resources based on real-time conditions determined based on the CLI measurement communications 220. Additionally, or alternatively, the network entities 105-a and 105-b may perform beam management techniques, change power control parameters, change coding and modulation schemes, perform interface cancellation on one or more identified resource elements, or a combination thereof. As such, the CLI measurement communications 220 may reduce gNB-to-gNB co-channel CLI, thus increasing the reliability of wireless communications in wireless communications system 200.

In some examples, the network entities 105-a and 105-b may increase the efficacy of the CLI measurement procedures by reducing interference based on communications from the UEs 115 serviced by the network entities 105. For example, the network entities 105-a and 105-b may operate in accordance with an uplink resource muting scheme, such that the network entities 105 may avoid scheduling the UEs 115 for uplink transmissions on resource elements scheduled for CLI measurements. In a first example, the network entity 105-a may operate in accordance with a transparent uplink resource muting method, where the network entity 105-a may avoid scheduling uplink transmissions over resources allocated for CLI measurement procedure 215-a. In a second example, the network entity 105-a may operate in accordance with a non-transparent uplink resource muting method, where the network entity 105-a may define an uplink resource muting pattern associated with one or more resource element muting patterns or resource block muting patterns. As such, the network entities 105 may use uplink resource muting to measure gNB-to-gNB CLI levels, to measure one or more gNB-to-gNB channels, to measure a gNB-to-gNB CLI interference covariance matrix, or a combination thereof with less interference from uplink.

As such, different muted uplink resources may be used to measure spatial characteristics of gNB-to-gNB CLI caused by various downlink signals to reduce CLI. In accordance with gNB-to-gNB co-channel CLI measurement the network entities 105 may support one or more muting techniques. For example, the network entities 105 may support muting resource elements in uplink slots at a position of an SSB, SIB1, and broad-cast physical downlink control channel (PDCCH) from cells that may be supported to measure the spatial characteristics of downlink broadcast interference. Additionally, or alternatively, the network entities 105 may support muting resource elements in uplink slots at a position of unicast physical downlink shared channel (PDSCH) and PDCCH from cells that may be supported to obtain the spatial characteristics of unicast PDSCH and PDCCH CLI. Additionally, or alternatively, the network entities 105 may support muting resource elements in an uplink slot at the position of resource elements of non-zero power (NZP) control state information reference signals (CSI-RS) from a cell that may be supported to avoid CLI above a CLI threshold.

As described herein, the network entities 105 may support non-transparent uplink resource muting for interference covariance matrix measurement for gNB-to-gNB CLI handling. In cases of non-transparent uplink resource muting, the network entities 105 may define one or more uplink resource muting patterns that the UEs 115 may operate in accordance with during the CLI measurement procedure 215. In some cases, the uplink resource muting patterns may be associated with one or more reference signal time-frequency resource patterns configured at the UEs 115 (e.g., a PTRS resource pattern, a comb-2 SRS resource pattern, among other examples). In some cases, however, the UEs 115 may be configured with or capable of performing respective sets of uplink resource muting patterns. That is, the UE 115-a may be capable of operating in accordance with a first set of uplink resource muting patterns while the UE 115-b may be capable of operating in accordance with a subset of the first set of uplink resource muting patterns. As such, it may be advantageous for each of the UEs 115 to identify a capability corresponding to uplink resource muting. Additionally, or alternatively, it may be advantageous for the network entities 105 and the UEs 115 to define collision mitigation scheme in cases where a scheduled uplink resource muting pattern overlaps with a scheduled DMRS or a scheduled PTRS. Additionally, or alternatively, it may be advantageous for the network entities 105 and the UEs 115 to define a PUSCH resource mapping scheme associated with rate-matching around muted resource elements. Additionally, or alternatively, it may be advantageous for the network entities 105 and the UEs 115 to define a UCI resource determination scheme in accordance with uplink resource muting at the UEs 115. Additionally, or alternatively, it may be advantageous for the network entities 105 and the UEs 115 to define a power allocation scheme associated with symbols that include muted uplink resource elements in accordance with phase continuity between respective symbols. Additionally, or alternatively, it may be advantageous for the network entities 105 and the UEs 115 to define a transport block size determination scheme for transport block transmission during symbols including muted resource elements.

As such, the UEs 115 may operate in accordance with an uplink resource muting procedure 240 in accordance with the techniques described herein. For example, the UE 115-a may transmit one or more muting capability messages 230 to the network entity 105-a, where the one or more muting capability messages 230 may indicate that the UE 115-a may support uplink resource muting in accordance with one or more uplink resource muting patterns.

In some examples, the one or more muting capability messages 230 may indicate support for an uplink resource muting pattern on a per uplink waveform type basis. For instance, the UE 115-a may indicate which uplink resource muting patterns of a set of uplink resource muting patterns that the UE 115-a supports for a cyclic prefix OFDM (CP-OFDM) waveform type, for a discrete Fourier Transform-spread (DFT-S)-OFDM waveform type, or both. By enabling the UE 115-a to indicate which respective uplink resource muting patterns are supported for each respective uplink waveform type, aspects of the present disclosure may enable improved coordination between the UE 115-a and the network by enabling the network to “know” which uplink muting patterns to expect or schedule for respective uplink waveforms to enable more efficient and reliable wireless communications.

In some examples, the UE 115-a may indicate different types of uplink resource muting patterns supported. For example, a first muting capability message 230 may indicate whether the UE 115-a supports a comb-2 SRS-like uplink resource muting pattern. In some cases, the comb-2 pattern may be an example of a frequency pattern with reference to resource elements or resource blocks. For instance, a comb-2 pattern may allocate muted uplink resources in every second subcarrier with a specified resource block (e.g., muted resource elements are allocated at positions 0, 2, 4, 6, etc., within a given resource block). While the techniques described herein discuss comb-2 SRS-like uplink pattern, it is understood that the UE 115-a may operate in accordance with uplink resource muting using various comb patterns (e.g., comb-2, comb-4, comb-8, etc.).

In some examples, a second muting capability message 230 may indicate whether the UE 115-a supports a zero power PTRS-like or a sparse in frequency uplink resource pattern. For example, the second muting capability message 230 may indicate one or more parameters indicating a time and frequency pattern associated with muting resources. For example, a first parameter (e.g., a K value) may indicate a pattern associated with muting frequency tones across a frequency carrier. For instance, if K is equal to four, then the UE 115-a may be capable of muting one frequency tone per four consecutive resource blocks, and if K is equal to two, then the UE 115-a may be capable of muting one frequency tone per two consecutive resource blocks. Additionally, or alternatively, a second parameter (e.g., an L value) may indicate a pattern associated with muting PUSCH symbols over a configured duration. For instance, if L is equal to one, then the UE 115-a may be capable of muting each PUSCH symbol spanning the duration. If L is equal to two, the UE 115-a may be capable of muting one symbol per two consecutive PUSCH symbols over the duration. If L is equal to 4, then the UE 115-a may be capable of muting one symbol per four consecutive PUSCH symbols over the duration.

In some examples, the UE 115-a may transmit a third muting capability message 230 that indicates whether the UE 115-a supports a comb-2 SRS-like uplink resource muting pattern on DFT-S-OFDM waveforms, on CP-OFDM waveforms, or both.

In some examples, the UE 115-a may transmit a fourth muting capability message 230 that indicates whether the UE 115-a supports a zero power PTRS-like or a sparse in frequency uplink resource muting pattern on DFT-S-OFDM waveforms, on CP-OFDM waveforms, or both.

In some examples, the one or more muting capability messages 230 may indicate a maximum uplink resource muting pattern (e.g., a maximum value of K and/or a maximum value of L) that the UE 115-a supports. Additionally, or alternatively, the one or more muting capability messages 230 may indicate a maximum uplink resource muting pattern that the UE 115-a supports per BWP. Additionally, or alternatively, the one or more muting capability messages 230 may indicate a maximum uplink resource muting pattern that the UE 115-a supports per waveform type (e.g., DFT-S-OFDM waveforms, CP-OFDM waveforms, etc.). In some cases, information pertaining to the maximum uplink resource muting pattern that the UE 115-a supports may be included in a single muting capability message 230 or over multiple respective muting capability messages 230.

In some examples, the one or more muting capability messages 230 may indicate one or more RRC modes that the UE 115-a supports while operating in accordance with an uplink resource muting pattern. For example, the one or more muting capability messages 230 may indicate whether the UE 115-a supports uplink resource muting patterns in RRC connected mode, in RRC inactive mode, in RRC idle mode, or a combination thereof. In some cases, information pertaining to the RRC modes supported by the UE 115-a during uplink resource muting may be included in a single muting capability message 230 or over multiple respective muting capability messages 230.

As described herein, the network entities 105 and the UEs 115 may define one or more rules for collision resolution between an uplink resource muting pattern and a scheduled DMRS. For instance, if a first set of muted resource elements associated with the resource muting pattern at least partially overlaps with a second set of resource elements scheduled for DMRS, the UE 115-a and the network entity 105-a may operate in accordance with one or more DMRS collision resolution protocols. In a first DMRS collision resolution protocol, the UE 115-a may determine to drop the DMRS and an associated PUSCH transmission based on the resource elements allocated to the DMRS overlapping with the set of muted resource elements. In a second DMRS collision resolution protocol, the UE 115-a may refrain from operating in accordance with (e.g., ignore) the uplink resource muting pattern and transmit the DMRS and an associated PUSCH transmission. In a third DMRS collision resolution protocol, the network entity 105-a may refrain from scheduling resource elements associated with DMRS that overlap with the first set of muted resource elements. In a fourth DMRS collision resolution protocol, the UE 115-a may determine to transmit the DMRS via a subset of the scheduled resource elements and an associated PUSCH transmission, where the subset of scheduled resource elements do not overlap with the first set of muted resource elements. In a fifth DMRS collision resolution protocol, the UE 115-a may not expect to have a DMRS and muted resource elements in a same symbol. That is, the network entity 105-a may refrain from scheduling DMRS and muted resource elements in a same symbol. As such, if the UE 115-a identifies DMRS and muted resource elements scheduled in a same symbol, the UE 115-a may determine an error case. In a sixth DMRS collision resolution protocol, the UE 115-a does not expect to have a DMRS and muted resource elements that overlap in frequency (e.g., can overlap in same symbols but different REs). That is, the network entity 105-a may refrain from scheduling a DMRS and muted resources during the same frequency resources of a same one or more symbols. As such, if the UE 115-a identifies DMRS and muted resource elements scheduled in a same symbol in the same frequency resources, the UE 115-a may determine an error case. Each of these DMRS collision resolution protocols provide specific rules or conditions that define how the UE 115-a is to behave with respect to muted resource elements and DMRSs, and thereby provide improved coordination between the UE 115-a and the network. Therefore, the DMRS collision resolution protocols, when agreed upon between the UE 115-a and the network, enable the UE 115-a and the network to share an understanding with respect to which communications will be performed to achieve improved reliability and fewer retransmissions.

As described herein, the network entities 105 and the UEs 115 may define one or more rules for collision resolution between an uplink resource muting pattern and a scheduled PTRS. For instance, if a first set of muted resource elements associated with the resource muting pattern at least partially overlaps with a second set of resource elements scheduled for PTRS, the UE 115-a and the network entity 105-a may operate in accordance with one or more PTRS collision resolution protocols. In a first PTRS collision resolution protocol, the UE 115-a may determine to transmit the PTRS via a subset of the scheduled resource elements, where the subset of scheduled resource elements do not overlap with the first set of muted resource elements (e.g., transmit the PTRS over resource elements that do not collide with the first set of muted resource elements). In a second PTRS collision resolution protocol, the UE 115-a may refrain from operating in accordance with (e.g., ignore) the uplink resource muting pattern and transmit the PTRS. In a third PTRS collision resolution protocol, the network entity 105-a may refrain from scheduling resource elements associated with PTRS that overlap with the first set of muted resource elements. In a fourth PTRS collision resolution protocol, the UE 115-a may not expect to have a PTRS and muted resource elements in a same OFDM symbol. That is, the network entity 105-a may refrain from scheduling PTRS and muted resource elements in a same OFDM symbol. As such, if the UE 115-a identifies PTRS and muted resource elements scheduled in a same OFDM symbol, the UE 115-a may determine an error case. In a fifth PTRS collision resolution protocol, the UE 115-a does not expect to have a PTRS and muted resource elements that overlap in frequency (e.g., can overlap in same symbols but different REs). That is, the network entity 105-a may refrain from scheduling a PTRS and muted resources during the same frequency resources of a same one or more symbols. As such, if the UE 115-a identifies PTRS and muted resource elements scheduled in a same OFDM symbol during the same frequency resources, the UE 115-a may determine an error case. Each of these PTRS collision resolution protocols provide specific rules or conditions that define how the UE 115-a is to behave with respect to muted resource elements and PTRSs, and thereby provide improved coordination between the UE 115-a and the network. Therefore, the PTRS collision resolution protocols, when agreed upon between the UE 115-a and the network, enable the UE 115-a and the network to share an understanding with respect to which communications will be performed to achieve improved reliability and fewer retransmissions.

As described herein, the network entities 105 and the UEs 115 may define one or more rules for collision resolution between an uplink resource muting pattern and a scheduled UCI transmission. For instance, if a first set of muted resource elements associated with the resource muting pattern at least partially overlaps with a second set of resource elements scheduled for a UCI transmission at the UE 115-a, the UE 115-a and the network entity 105-a may operate in accordance with one or more UCI collision resolution protocols. In a first UCI collision resolution protocol, the network entity 105-a may refrain from scheduling resource elements associated with UCI that overlap with the first set of muted resource elements. In a second UCI collision resolution protocol, the UE 115-a may not expect to have a UCI and muted resource elements in a same OFDM symbol. That is, the network entity 105-a may refrain from scheduling UCI and muted resource elements in a same OFDM symbol. As such, if the UE 115-a identifies UCI and muted resource elements scheduled in a same OFDM symbol, the UE 115-a may determine an error case. In a third UCI collision resolution protocol, the UE 115-a does not expect to have a UCI and muted resource elements that overlap in frequency (e.g., can overlap in same symbols but different REs). That is, the network entity 105-a may refrain from scheduling a UCI transmission and muted resources during the same frequency resources of a same one or more symbols. As such, if the UE 115-a identifies UCI and muted resource elements scheduled in a same OFDM symbol that overlap in frequency, the UE 115-a may determine an error case. Each of these UCI collision resolution protocols provide specific rules or conditions that define how the UE 115-a is to behave with respect to muted resource elements and UCI, and thereby provide improved coordination between the UE 115-a and the network. Therefore, the UCI collision resolution protocols, when agreed upon between the UE 115-a and the network, enable the UE 115-a and the network to share an understanding with respect to which communications will be performed to achieve improved reliability and fewer retransmissions.

In some examples, the UE 115-a does not expect to have an overlapping UCI transmission and PUSCH transmission in a same OFDM symbol if the PUSCH is allocated with less than a configured threshold quantity of resource blocks, the PUSCH is allocated with less than a configured threshold quantity of symbols, or both. As such, if the UE 115-a identifies an overlapping UCI transmission and PUSCH transmission in a same OFDM symbol while the PUSCH is allocated with a quantity of resource block greater than the configured threshold or a quantity of symbols greater than the configured threshold, the UE 115-a may determine an error case.

As described herein, the network entities 105 and the UEs 115 may define one or more rules for collision resolution between an uplink resource muting pattern and a scheduled PUSCH transmission. For instance, if a first set of muted resource elements associated with the resource muting pattern at least partially overlaps with a second set of resource elements scheduled for a PUSCH transmission at the UE 115-a, the UE 115-a and the network entity 105-a may operate in accordance with one or more PUSCH collision resolution protocols. In a first example, the UE 115-a may transmit the PUSCH transmission based on the PUSCH transmission being allocated with less than a threshold quantity of resource blocks, being allocated with less than a threshold quantity of symbols, or both. In such a first example, the UE refrains from muting the first set of muted resource elements. By transmitting the PUSCH transmission (instead of transmitting the first set of muted resource elements), throughput between the UE 115-a and the network entity 105-a may be increased.

In some cases of non-transparent uplink resource muting for gNB-to-gNB CLI mitigation for SBFD operation, a performance gain may be associated with loading characteristics of the network. That is, if downlink loading is reduced at network entity 105-b (e.g., an aggressor gNB), it may be advantageous for the network entity 105-a (e.g., a victim gNB) to deactivate uplink resource muting for CLI mitigation. Additionally, or alternatively, if loading increases at the network entity 105-b, it may be advantageous for the network entity 105-a to activate uplink resource muting for CLI mitigation. As such, the network entities 105 may determine to activate or deactivate one or more uplink resource muting patterns for CLI mitigation. For example, the network entity 105-a may transmit to the UE 115-a a muting pattern configuration 225, which may be an example of a first control message (e.g., RRC signaling). In some examples, the muting pattern configuration 225 may indicate one or more semi-static uplink resource muting patterns for use at the UE 115-a. That is, the network entity 105-a may configure the UE 115-a with the one or more uplink resource muting patterns.

Additionally, or alternatively, the network entity 105-a may transmit a muting pattern indication 235, which may be an example of a second control message (e.g., a medium access control-control element (MAC-CE) message, a group common (GC)-DCI message, or a dynamic DCI message). In some examples, the muting pattern indication 235 may activate or deactivate one or more uplink resource muting patterns at the UE 115-a. For example, if the muting pattern configuration 225 configured a single uplink resource muting pattern at the UE 115-a, then the muting pattern indication 235 may include a single bit indication, where a first value of the single bit (e.g., “1”) activates the single uplink resource pattern for use by the UE 115-a and a second value of the single bit (e.g., “0”) deactivates the single uplink resource muting pattern for use by the UE 115-a. In some other examples, the muting pattern configuration 225 may configure the UE 115-a with multiple uplink resource muting patterns. In such other examples, the muting pattern indication 235 may include a multiple bit indication, where respective values of the multiple bit indication may be associated with activating and deactivating respective uplink resource muting patterns. For example, a first value of the multiple bit indication (e.g., “00”) may deactivate each of the multiple uplink resource muting patterns, a second value of the multiple bit indication (e.g., “01”) may activate a first uplink resource muting pattern, a third value of the multiple bit indication (e.g., “10”) may activate a second uplink resource muting pattern, and so on. As described herein, the multiple bit indication may include any quantity of bits that are associated with activating or deactivating any quantity of uplink resource muting patterns at the UE 115-a. Additionally, or alternatively, the activated uplink resource muting pattern may be associated with waveform type indicated for the UE 115-a (e.g., DFT-S-OFDM or CP-OFDM) as part of the one or more muting capability messages 230. Additionally, or alternatively, the uplink resource muting pattern activated at the UE 115-a via the muting pattern indication 235 may remain activated until reception of a second muting pattern indication 235 that indicates a different uplink resource muting pattern activation scheme. That is the activation of a given uplink resource muting pattern at the UE 115-a is sticky (e.g., persists) until subsequent indication by the network entity 105-a for deactivation or reactivation. In cases where the muting pattern indication 235 is dynamic DCI message, the UE 115-a may interpret an existing field of the dynamic DCI message for reception of the one or more bits indicating which uplink resource muting pattern to activate or deactivate (e.g., the csi-request field or another field of the dynamic DCI).

As described herein, the network entities 105 and the UEs 115 may define one or more rules for transport block size determination in accordance with operation with an uplink resource muting pattern. In a first example, the network entities 105 and the UEs 115 may determine a quantity of resource blocks (e.g., number of physical resource blocks (nPRBs)) for a transport block size calculation as the quantity of resource blocks allocated or assigned to the given transport block (e.g., including resource elements muted in accordance with an uplink resource muting pattern). In a second example, the network entities 105 and the UEs 115 may determine a quantity of resource blocks (e.g., nPRBs) for a transport block size calculation as the quantity of resource blocks allocated or assigned to the given transport block that excludes resource elements muted in accordance with an uplink resource muting pattern.

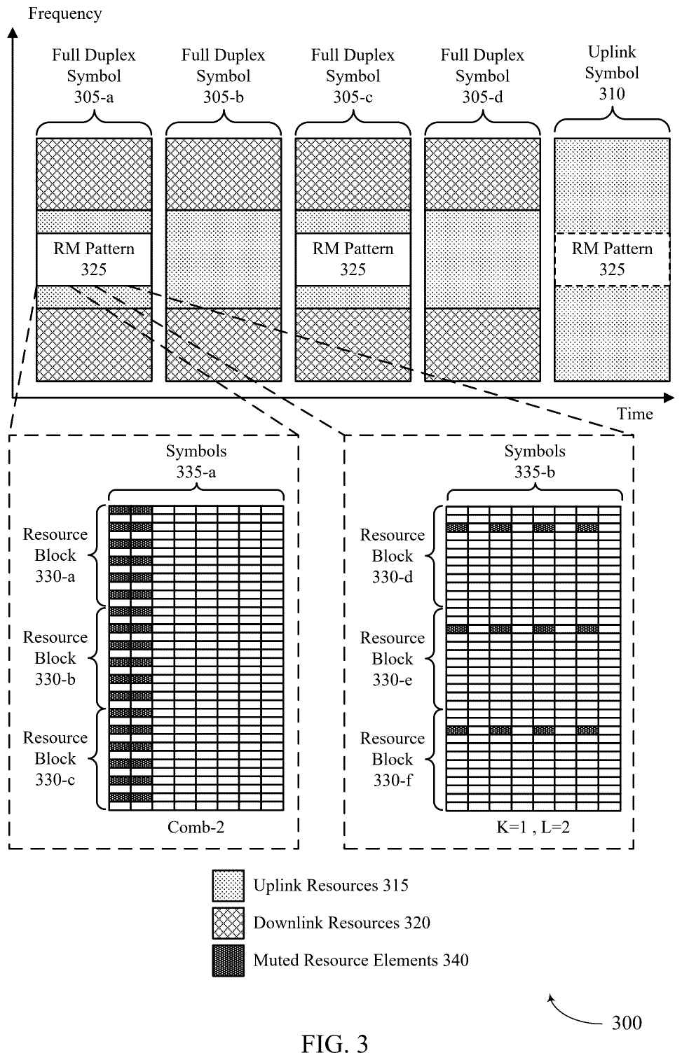

FIG. 3 shows an example of a muting pattern operation scheme 300 that supports techniques for uplink resource muting at wireless devices in accordance with one or more aspects of the present disclosure. The muting pattern operation scheme 300 may implement or may be implemented by aspects of the wireless communications system 100 and 200. For example, the muting pattern operation scheme 300 may include a resource muting pattern 325, which may be an example of an uplink resource muting pattern used by a UE 115 during CLI measurements between multiple network entities 105, as described with reference to FIG. 2.

As illustrated in FIG. 3, a UE 115 may be configured with one or more full duplex symbols 305 (e.g., full duplex symbol 305-a, 305-b, 305-c, and 305-d). In some examples, the full duplex symbols 305 may be SBFD symbols. For instance, as illustrated in FIG. 3, the full duplex symbols 305 span a frequency band, where one or more first subbands of the frequency band are configured as uplink resources 315 and one or more second subbands of the frequency band are configured as downlink resources 320.

Additionally, as illustrated in FIG. 3, the UE 115 may operate in accordance with resource muting pattern 325 during one or more of the full duplex symbols 305 (e.g., during full duplex symbol 305-a and 305-c). For instance, the UE may receive a control message from a network entity 105 that semi-statically configures the resource muting pattern 325 for use at the UE (e.g., indicated in the muting pattern configuration 225). In some examples, the network entity 105 may semi-statically configure the resource muting pattern 325 with an associated periodicity. For instance, in the example of FIG. 3, the resource muting pattern 325 is configured with a periodicity such that the UE 115 may operate in accordance with the resource muting pattern 325 during every other symbol. However, it is understood that the resource muting pattern 325 may be associated with any quantity of different periodicities. Configuring the resource muting pattern 325 with some periodicity, such as in every other symbol (instead of in every symbol), may reduce how often the UE 115 is expected to perform resource muting, and may increase throughput between the UE 115 and the network on those resources (e.g., symbols, slots) for which the resource muting pattern 325 is not configured/enabled.

Additionally, the resource muting pattern 325 may be associated with or correspond to a type of resource muting pattern as described with reference to FIG. 3 (e.g., comb-2 SRS-like or zero power PTRS-like). In a first example, the resource muting pattern 325 may operate in accordance with a comb-2 SRS-like pattern. For instance, as illustrated in FIG. 3, a set of muted resource elements 340 may span every other resource element across a set of consecutive resource blocks 330 (e.g., resource block 330-a, 330-b, and 330-c). Additionally, in the first example, the muted resource elements 340 may span one or more symbols 335-a. For instance, while FIG. 3 illustrates the muted resource elements spanning two consecutive symbols, it is understood that the muted resource elements 340 may span any quantity of consecutive or non-consecutive symbols in accordance with the comb-2 SRS-like pattern. In a second example, the resource muting pattern 325 may operate in accordance with a zero power PTRS-like pattern. For instance, as illustrated in FIG. 3, the muting pattern 325 may be associated with a K value of one, indicating to mute resource elements once per resource block 330 of a set of resource blocks (e.g., resource block 330-d, 330-c, and 330-f) and associated with an L value of two, indicating to mute every other resource element across a set of symbols 335-b. As described herein, the K value and L value may each be any integer value.

In some cases, however, the periodicity associated with the resource muting pattern 325 may not align with symbol types corresponding to CLI mitigation (e.g., SBFD pattern periodicity). For example, as described herein, the UE may operate in accordance with resource muting pattern 325 for gNB-to-gNB CLI mitigation during SBFD operation. However, the periodicity associated with the resource muting pattern 325 may indicate for the UE 115 to use the resource muting pattern during non-full duplex symbols. For example, as illustrated in FIG. 3, subsequent to the full duplex symbol 305-d, the UE 115 is scheduled for an uplink symbol 310 (e.g., a non-SBFD symbol).

In accordance with the techniques described herein, the UE 115 may refrain from operating in accordance with the resource muting pattern 325 during non-full duplex and non-SBFD symbols. That is, the UE 115 may ignore or drop the configured or indicated resource muting pattern 325 during the uplink symbol 310. Additionally, or alternatively, the UE may refrain from performing uplink rate matching associated with the resource muting pattern 325 during the uplink symbol 310 (e.g., or any other non-full duplex and non-SBFD symbols). During non-full duplex and non-SBFD symbols, such as the uplink symbol 310, the network entity (and other network entities) may not be expected to perform downlink communications. As such, there may be no CLI to be measured, and therefore no benefit to performing uplink resource muting. As such, by refraining from performing resource muting during non-full duplex and non-SBFD symbols, throughput may be increased without affecting the ability of the network entity to perform CLI measurement (as there may be no downlink signals from neighboring network entities to measure).

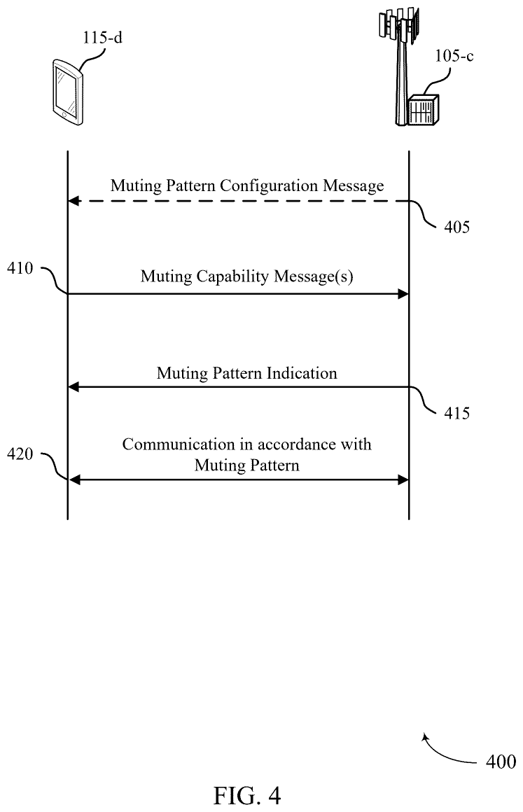

FIG. 4 shows an example of a process flow 400 that supports techniques for uplink resource muting at wireless devices in accordance with one or more aspects of the present disclosure. In some examples, process flow 400 may implement aspects of wireless communications system 100, wireless communications system 200, and muting pattern operation scheme 300. Process flow 400 may include a UE 115-d which may be an example of a UE 115, as described with reference to FIGS. 1 through 3. Additionally, process flow 400 may include a network entity 105-c which may be an example of a network entity 105, as described with reference to FIGS. 1 through 3. Alternative examples of the following may be implemented, where some steps are performed in a different order than described or are not performed at all. In some cases, steps may include additional features not mentioned below, or further steps may be added. In addition, it is understood that these processes may occur between any quantity of network devices and network device types.

At signaling operation 405, the UE 115-d may optionally receive from the network entity 105-c a first control message that configures the UE 115-d with the one or more resource muting patterns. For example, the first control message may be an example of the muting pattern configuration 225, as described with reference to FIG. 2. In some examples, the muting pattern configuration message may configure the UE 115-d with a single resource muting pattern or with multiple resource muting patterns.

At signaling operation 410, the UE 115-d may transmit to the network entity 105-c at least one muting capability message. For instance, the at least one muting capability message may be an example of one or more of the muting capability messages 230, as described with reference to FIG. 2. In some examples, the at least one capability message may indicate that the UE 115-d supports uplink resource muting in accordance with one or more resource muting patterns, where each resource muting pattern of the one or more resource muting patterns is associated with a respective set of resource elements. In some examples, the respective set of resource elements may be associated with a CLI measurement, where uplink transmissions on the respective set of resource elements are muted during the CLI measurement.

In some examples, the at least one capability message indicates that the uplink resource muting is supported by the UE 115-d in accordance with the one or more resource muting patterns on a per uplink waveform type basis. In some cases, each resource muting pattern of the one or more resource muting patterns is rate matched in accordance with a set of muted resource elements corresponding to each resource muting pattern. For instance, if the UE 115-d is scheduled for an uplink transmission over a first set of resource elements adjacent to the muted resource elements, the UE 115-d may perform rate matching around the muted resources (e.g., in the first set of resource elements).

In some examples, the one or more resource muting patterns may include at least one of a first resource muting pattern including a comb-2 SRS-like muting pattern, a second muting pattern including a zero power PTRS-like resource muting pattern or a sparse in frequency resource muting pattern, a third muting pattern including a comb-2 SRS-like muting pattern for DFT-S-OFDM, for CP-OFDM, or both, or a fourth muting pattern including a zero power PTRS-like resource muting pattern or a sparse in frequency resource muting pattern, the fourth muting pattern for DFT-S-OFDM, for CP-OFDM, or both.

In some examples, the at least one capability message may include an indication of a maximum quantity of uplink resource muting patterns supported by the UE 115-d, an indication of a respective maximum quantity of uplink resource muting patterns supported by the UE 115-d for each BWP of a set of BWPs, an indication of a respective maximum quantity of uplink resource muting patterns supported by the UE 115-d for each waveform of a set of waveforms, or a combination thereof.

In some examples, the at least one capability message may include an indication that the UE 115-d supports the uplink resource muting for an RRC connected mode, for an RRC inactive mode, for an RRC idle mode, or a combination thereof.

At signaling operation 415, the UE 115-d may receive from the network entity 105-c a muting pattern indication. For instance, the muting pattern indication may be an example of the muting pattern indication 235 as described with reference to FIG. 2. In some examples, the UE 115-d may receive the muting pattern indication which may indicate for the UE 115-d to operate in accordance with a resource muting pattern of the one or more resource muting patterns based on transmission of the at least one capability message.

In some examples, the muting pattern indication may be a second control message that includes one or more bits that indicates activation or deactivation of the resource muting pattern, where the indication to operate in accordance with the resource muting pattern is based on the one or more bits. For example, the muting pattern indication may include a set of bits, where a first value of the set of bits indicates deactivation for each of the set of resource muting patterns and one or more second values of the set of bits respectively indicate activation of a respective resource muting pattern of the set of resource muting patterns. In some examples, the muting pattern indication is a MAC-CE message. In some examples, the muting pattern indication is a GC-DCI message. In some examples, the muting pattern indication is a dynamic DCI.

At signaling operation 420, the UE 115-d and the network entity 105-c may communicate in accordance with the resource muting pattern based on reception of the muting pattern indication. For example, communicating in accordance with the resource muting pattern is further based on the communication occurring during one or more SBFD symbols or one or more full duplex symbols (e.g., as described with reference to FIG. 3).

In some cases, a first set of muted resource elements associated with the resource muting pattern at least partially overlaps with a second set of resource elements scheduled for a DMRS (e.g., based on the indicated resource muting pattern and a scheduled DMRS). As such, the UE 115-d and network entity 105-c may operate in accordance with one or more rules for DMRS collision resolution. In a first example, the UE 115-d may drop the DMRS based on the first set of muted resource elements at least partially overlapping with the second set of resource elements scheduled for the DMRS and mute the first set of muted resource elements based on dropping the DMRS. In a second example, the UE 115-d may transmit the DMRS and an associated uplink data message, where the UE 115-d refrains from muting the first set of muted resource elements based on the first set of muted resource elements at least partially overlapping with the second set of resource elements scheduled for the DMRS. In a third example, the UE 115-d may transmit, via a subset of the second set of resource elements, the DMRS and an associated uplink data message, where the subset of the second set of resource elements includes one or more resource elements that do not overlap with the first set of muted resource elements and mute a subset of the first set of muted resource elements that do not overlap with the second set of resource elements. In a fourth example, the network entity 105-c may not schedule a subset of the second set of resource elements that overlap with a subset of the first set of muted resource elements. In a fifth example, the network entity 105-c may not schedule a subset of the second set of resource elements that overlap in a same symbol with a subset of the first set of muted resource elements (e.g., otherwise the UE 115-d may determine an error case). In a sixth example, the network entity 105-c may not schedule a subset of the second set of resource elements that overlap in a same symbol and a same frequency carrier with a subset of the first set of muted resource elements (e.g., otherwise the UE 115-d may determine an error case). Each of these DMRS collision resolution protocols provide specific rules or conditions that define how the UE 115-d is to behave with respect to muted resource elements and DMRSs, and thereby provide improved coordination between the UE 115-d and the network. Therefore, the DMRS collision resolution protocols, when agreed upon between the UE 115-d and the network, enable the UE 115-d and the network to share an understanding with respect to which communications will be performed to achieve improved reliability and fewer retransmissions.

In some cases, where a first set of muted resource elements associated with the resource muting pattern at least partially overlaps with a second set of resource elements scheduled for a PTRS. As such, the UE 115-d and network entity 105-c may operate in accordance with one or more rules for PTRS collision resolution. In a first example, the UE 115-d may transmit the PTRS via a subset of the second set of resource elements, where the subset of the second set of resource elements includes one or more resource elements that do not overlap with the first set of muted resource elements and mute a subset of the first set of muted resource elements that do not overlap with the second set of resource elements. In a second example, the UE 115-d may transmit the PTRS via the second set of resource elements, where the UE 115-d refrains from muting the first set of muted resource elements based on the first set of muted resource elements at least partially overlapping with the second set of resource elements scheduled for the PTRS. In a third example, the network entity 105-c may not schedule a subset of the second set of resource elements that overlap with a subset of the first set of muted resource elements. In a fourth example, the network entity 105-c may not schedule a subset of the second set of resource elements that overlap in a same OFDM symbol with a subset of the first set of muted resource elements (e.g., otherwise the UE 115-d may determine an error case). In a fifth example, the network entity 105-c may not schedule a subset of the second set of resource elements that overlap in a same symbol and a same frequency carrier with a subset of the first set of muted resource elements (e.g., otherwise the UE 115-d may determine an error case). Each of these PTRS collision resolution protocols provide specific rules or conditions that define how the UE 115-d is to behave with respect to muted resource elements and PTRSs, and thereby provide improved coordination between the UE 115-d and the network. Therefore, the PTRS collision resolution protocols, when agreed upon between the UE 115-d and the network, enable the UE 115-d and the network to share an understanding with respect to which communications will be performed to achieve improved reliability and fewer retransmissions.

In some cases, a first set of muted resource elements associated with the resource muting pattern at least partially overlaps with a second set of resource elements scheduled for UCI. As such, the UE 115-d and network entity 105-c may operate in accordance with one or more rules for UCI collision resolution. In a first example, the network entity 105-c may not schedule a subset of the second set of resource elements that overlap with a subset of the first set of muted resource elements. In a second example, the network entity 105-c may not schedule a subset of the second set of resource elements that overlap in a same OFDM symbol with a subset of the first set of muted resource elements (e.g., otherwise the UE 115-d may determine an error case). In a third example, the network entity 105-c may not schedule a subset of the second set of resource elements that overlap in a same symbol and a same frequency carrier with a subset of the first set of muted resource elements (e.g., otherwise the UE 115-d may determine an error case). In some examples, the network entity 105-c may not schedule UCI that overlaps with a PUSCH in a same OFDM symbol based on the PUSCH being allocated with less than a threshold quantity of resource blocks, being allocated with less than a threshold quantity of symbols, or both. Each of these UCI collision resolution protocols provide specific rules or conditions that define how the UE 115-d is to behave with respect to muted resource elements and UCI, and thereby provide improved coordination between the UE 115-d and the network. Therefore, the UCI collision resolution protocols, when agreed upon between the UE 115-d and the network, enable the UE 115-d and the network to share an understanding with respect to which communications will be performed to achieve improved reliability and fewer retransmissions.

In some examples, the UE 115-d and the network entity 105-c may perform a transport block size calculation for a transport block transmission while the UE 115-d operates in accordance with an uplink resource muting pattern. In a first example, the UE 115-d may determine as part of a transport block size calculation, a quantity of resource blocks associated with a CLI measurement, where an allocated quantity of resource blocks is equal to the quantity of resource blocks scheduled during the CLI measurement. In a second example, the UE 115-d may determine as part of a transport block size calculation, a quantity of resource blocks associated with a CLI measurement, where an allocated quantity of resource blocks is equal to the quantity of resource blocks scheduled during the CLI measurement that do not overlap with a first set of muted resource elements.

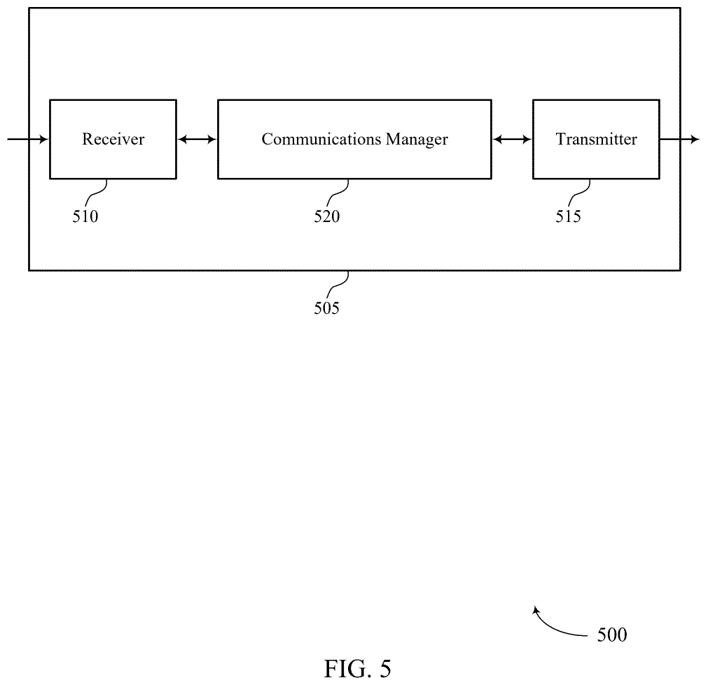

FIG. 5 shows a block diagram 500 of a device 505 that supports techniques for uplink resource muting at wireless devices in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for uplink resource muting at wireless devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for uplink resource muting at wireless devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for uplink resource muting at wireless devices as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting at least one capability message indicating that the UE supports uplink resource muting in accordance with one or more resource muting patterns, where each resource muting pattern of the one or more resource muting patterns is associated with a respective set of resource elements. The communications manager 520 is capable of, configured to, or operable to support a means for receiving an indication to operate in accordance with a resource muting pattern of the one or more resource muting patterns based on transmission of the at least one capability message. The communications manager 520 is capable of, configured to, or operable to support a means for communicating in accordance with the resource muting pattern based on reception of the indication.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, more efficient utilization of communication resources.

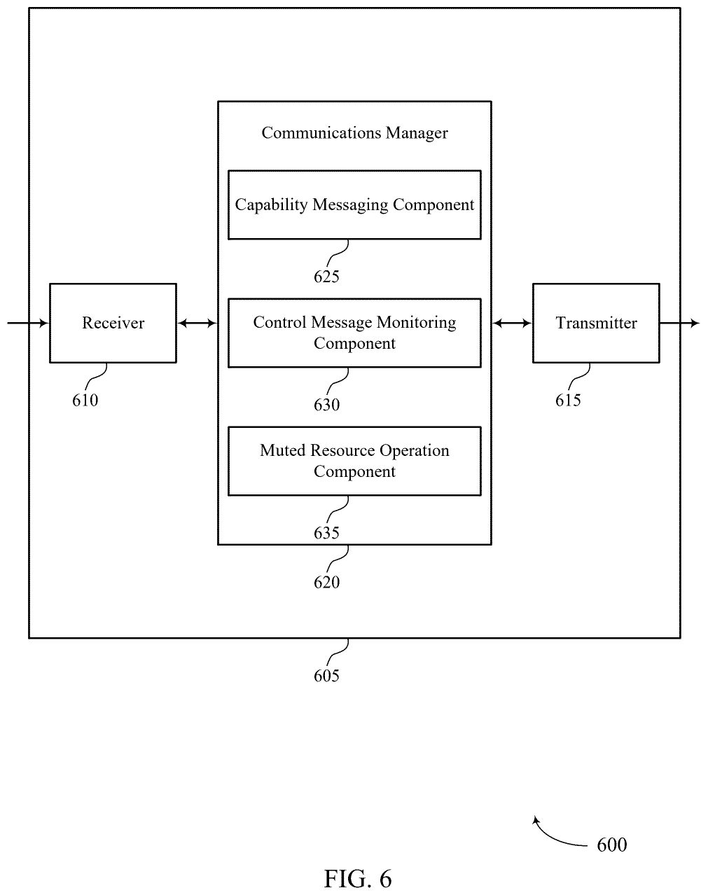

FIG. 6 shows a block diagram 600 of a device 605 that supports techniques for uplink resource muting at wireless devices in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for uplink resource muting at wireless devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for uplink resource muting at wireless devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for uplink resource muting at wireless devices as described herein. For example, the communications manager 620 may include a capability messaging component 625, a control message monitoring component 630, a muted resource operation component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The capability messaging component 625 is capable of, configured to, or operable to support a means for transmitting at least one capability message indicating that the UE supports uplink resource muting in accordance with one or more resource muting patterns, where each resource muting pattern of the one or more resource muting patterns is associated with a respective set of resource elements. The control message monitoring component 630 is capable of, configured to, or operable to support a means for receiving an indication to operate in accordance with a resource muting pattern of the one or more resource muting patterns based on transmission of the at least one capability message. The muted resource operation component 635 is capable of, configured to, or operable to support a means for communicating in accordance with the resource muting pattern based on reception of the indication.

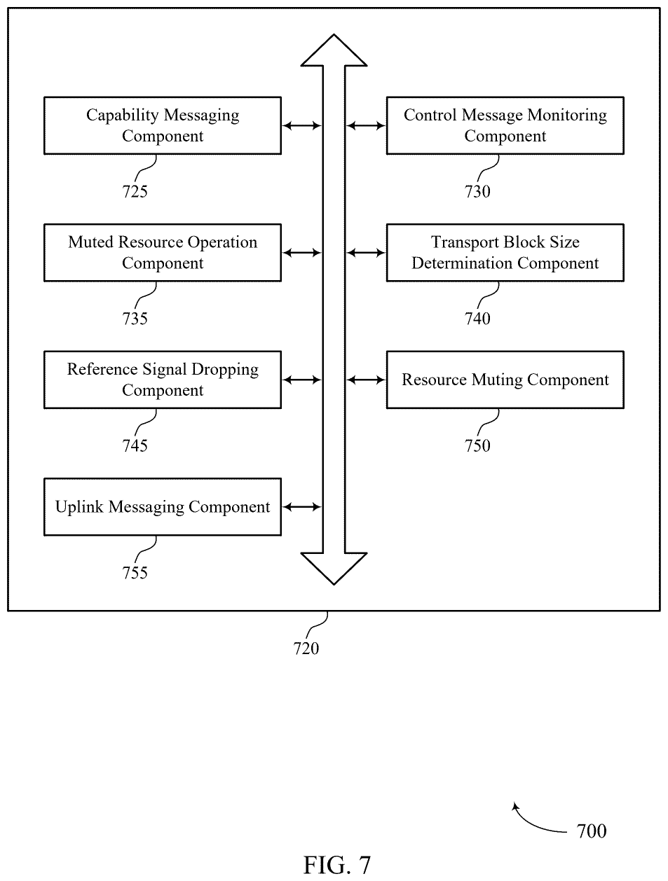

FIG. 7 shows a block diagram 700 of a communications manager 720 that supports techniques for uplink resource muting at wireless devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for uplink resource muting at wireless devices as described herein. For example, the communications manager 720 may include a capability messaging component 725, a control message monitoring component 730, a muted resource operation component 735, a transport block size determination component 740, a reference signal dropping component 745, a resource muting component 750, an uplink messaging component 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The capability messaging component 725 is capable of, configured to, or operable to support a means for transmitting at least one capability message indicating that the UE supports uplink resource muting in accordance with one or more resource muting patterns, where each resource muting pattern of the one or more resource muting patterns is associated with a respective set of resource elements. The control message monitoring component 730 is capable of, configured to, or operable to support a means for receiving an indication to operate in accordance with a resource muting pattern of the one or more resource muting patterns based on transmission of the at least one capability message. The muted resource operation component 735 is capable of, configured to, or operable to support a means for communicating in accordance with the resource muting pattern based on reception of the indication.

In some examples, the at least one capability message indicates that the uplink resource muting is supported by the UE in accordance with the one or more resource muting patterns on a per uplink waveform type basis.

In some examples, each resource muting pattern of the one or more resource muting patterns is rate matched in accordance with a set of muted resource elements corresponding to each resource muting pattern.

In some examples, the one or more resource muting patterns include at least one of a first resource muting pattern including a comb-2 SRS-like muting pattern; a second muting pattern including a zero power PTRS-like resource muting pattern or a sparse in frequency resource muting pattern; a third muting pattern including a comb-2 SRS-like muting pattern for DFT-S-OFDM, for cyclic prefix orthogonal frequency division multiplexing (CP-OFDM), or both; or a fourth muting pattern including a zero power PTRS-like resource muting pattern or a sparse in frequency resource muting pattern, the fourth muting pattern for DFT-S-OFDM, for CP-OFDM, or both.

In some examples, the capability messaging component 725 is capable of, configured to, or operable to support a means for transmitting, as part of the at least one capability message, an indication of a maximum quantity of uplink resource muting patterns supported by the UE, an indication of a respective maximum quantity of uplink resource muting patterns supported by the UE for each BWP of a set of BWPs, an indication of a respective maximum quantity of uplink resource muting patterns supported by the UE for each waveform of a set of waveforms, or a combination thereof.

In some examples, to support transmitting the at least one capability message, the capability messaging component 725 is capable of, configured to, or operable to support a means for transmitting an indication that the UE supports the uplink resource muting for an RRC connected mode, for an RRC inactive mode, for an RRC idle mode, or a combination thereof.

In some examples, communicating in accordance with the resource muting pattern is further based on one or more symbols being SBFD symbols or full duplex symbols.

In some examples, a first set of muted resource elements associated with the resource muting pattern at least partially overlaps with a second set of resource elements scheduled for a DMRS.

In some examples, to support communicating in accordance with the resource muting pattern, the reference signal dropping component 745 is capable of, configured to, or operable to support a means for dropping the DMRS based on the first set of muted resource elements at least partially overlapping with the second set of resource elements scheduled for the DMRS. In some examples, to support communicating in accordance with the resource muting pattern, the resource muting component 750 is capable of, configured to, or operable to support a means for muting the first set of muted resource elements based on dropping the DMRS.

In some examples, to support communicating in accordance with the resource muting pattern, the uplink messaging component 755 is capable of, configured to, or operable to support a means for transmitting the DMRS and an associated uplink data message, where the UE refrains from muting the first set of muted resource elements based on the first set of muted resource elements at least partially overlapping with the second set of resource elements scheduled for the DMRS.

In some examples, to support communicating in accordance with the resource muting pattern, the uplink messaging component 755 is capable of, configured to, or operable to support a means for transmitting, via a subset of the second set of resource elements, the DMRS and an associated uplink data message, where the subset of the second set of resource elements includes one or more resource elements that do not overlap with the first set of muted resource elements. In some examples, to support communicating in accordance with the resource muting pattern, the resource muting component 750 is capable of, configured to, or operable to support a means for muting a subset of the first set of muted resource elements that do not overlap with the second set of resource elements.

In some examples, the UE determines an error case based on a subset of the second set of resource elements overlapping in a same symbol with a subset of the first set of muted resource elements.

In some examples, the UE determines an error case based on a subset of the second set of resource elements overlapping in a same symbol and a same frequency carrier with a subset of the first set of muted resource elements.

In some examples, the transport block size determination component 740 is capable of, configured to, or operable to support a means for determining, as part of a transport block size calculation, a quantity of resource blocks associated with a CLI measurement, where an allocated quantity of resource blocks is equal to the quantity of resource blocks scheduled during the CLI measurement.

In some examples, the transport block size determination component 740 is capable of, configured to, or operable to support a means for determining, as part of a transport block size calculation, a quantity of resource blocks associated with a CLI measurement, where an allocated quantity of resource blocks is equal to the quantity of resource blocks scheduled during the CLI measurement that do not overlap with a first set of muted resource elements.

In some examples, a first set of muted resource elements associated with the resource muting pattern at least partially overlaps with a second set of resource elements scheduled for a PTRS.

In some examples, to support communicating in accordance with the resource muting pattern, the uplink messaging component 755 is capable of, configured to, or operable to support a means for transmitting the PTRS via a subset of the second set of resource elements, where the subset of the second set of resource elements includes one or more resource elements that do not overlap with the first set of muted resource elements. In some examples, to support communicating in accordance with the resource muting pattern, the resource muting component 750 is capable of, configured to, or operable to support a means for muting a subset of the first set of muted resource elements that do not overlap with the second set of resource elements.

In some examples, to support communicating in accordance with the resource muting pattern, the uplink messaging component 755 is capable of, configured to, or operable to support a means for transmitting the PTRS via the second set of resource elements, where the UE refrains from muting the first set of muted resource elements based on the first set of muted resource elements at least partially overlapping with the second set of resource elements scheduled for the PTRS.

In some examples, the UE determines an error case based on a subset of the second set of resource elements overlapping in a same symbol with a subset of the first set of muted resource elements.

In some examples, the UE determines an error case based on a subset of the second set of resource elements overlapping in a same symbol and a same frequency carrier with a subset of the first set of muted resource elements.

In some examples, a first set of muted resource elements associated with the resource muting pattern at least partially overlaps with a second set of resource elements scheduled for UCI.

In some examples, the UE determines an error case based on a subset of the second set of resource elements overlapping in a same OFDM symbol with a subset of the first set of muted resource elements.

In some examples, the UE determines an error case based on a subset of the second set of resource elements that overlap in a same symbol and a same frequency carrier with a subset of the first set of muted resource elements.

In some examples, the UE determines an error case in accordance with UCI overlapping with an PUSCH in a same OFDM symbol based on the PUSCH being allocated with less than a threshold quantity of resource blocks, being allocated with less than a threshold quantity of symbols, or both.

In some examples, a first set of muted resource elements associated with the resource muting pattern at least partially overlaps with a second set of resource elements scheduled for an PUSCH message.

In some examples, the uplink messaging component 755 is capable of, configured to, or operable to support a means for transmitting the PUSCH message based on the PUSCH message being allocated with less than a threshold quantity of resource blocks, being allocated with less than a threshold quantity of symbols, or both, where the UE refrains from muting the first set of muted resource elements.

In some examples, the control message monitoring component 730 is capable of, configured to, or operable to support a means for receiving a first control message that configures the UE with the one or more resource muting patterns. In some examples, the control message monitoring component 730 is capable of, configured to, or operable to support a means for receiving a second control message that includes one or more bits that indicates activation or deactivation of the resource muting pattern, where the indication to operate in accordance with the resource muting pattern is based on the one or more bits.

In some examples, the first control message configures the UE with a set of multiple resource muting patterns; and the second control message includes a set of multiple bits, a first value of the set of multiple bits indicates deactivation for each of the set of multiple resource muting patterns and one or more second values of the set of multiple bits respectively indicate activation of a respective resource muting pattern of the set of multiple resource muting patterns.

In some examples, the second control message is a MAC-CE message.

In some examples, the second control message is a GC-DCI message.

In some examples, the second control message is a DCI message and the one or more bits are included in a field of the DCI message.

In some examples, the respective set of resource elements are at least in part associated with a CLI measurement. In some examples, uplink transmissions on the respective set of resource elements are muted during the CLI measurement.

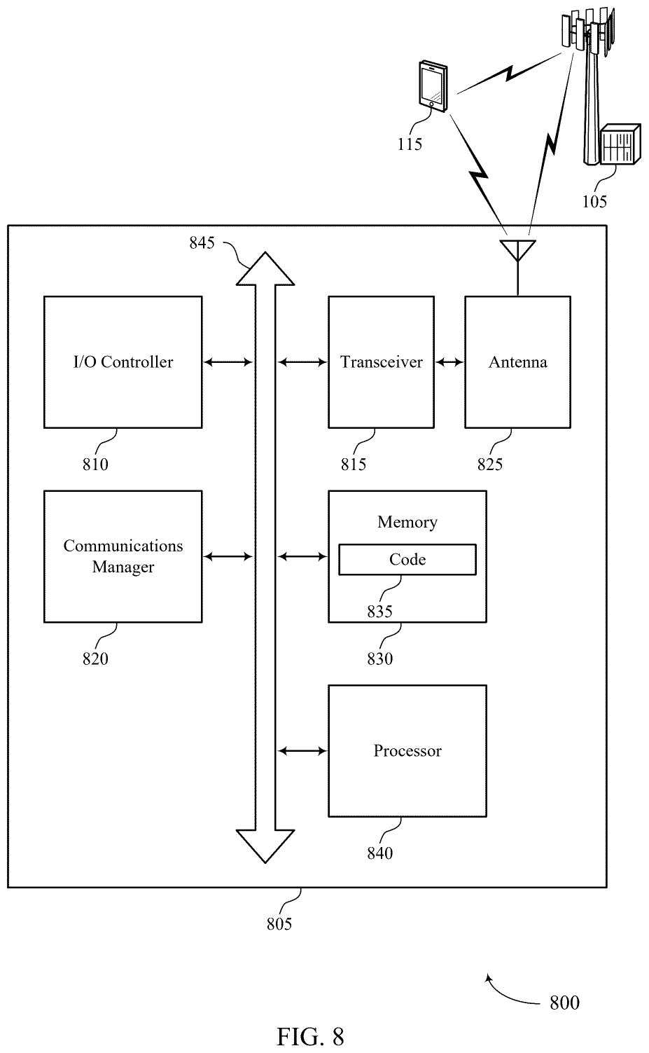

FIG. 8 shows a diagram of a system 800 including a device 805 that supports techniques for uplink resource muting at wireless devices in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for uplink resource muting at wireless devices). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting at least one capability message indicating that the UE supports uplink resource muting in accordance with one or more resource muting patterns, where each resource muting pattern of the one or more resource muting patterns is associated with a respective set of resource elements. The communications manager 820 is capable of, configured to, or operable to support a means for receiving an indication to operate in accordance with a resource muting pattern of the one or more resource muting patterns based on transmission of the at least one capability message. The communications manager 820 is capable of, configured to, or operable to support a means for communicating in accordance with the resource muting pattern based on reception of the indication.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for uplink resource muting at wireless devices as described herein, or the at least one processor 840 and the at least one memory 830 may be otherwise configured to, individually or collectively, perform or support such operations.

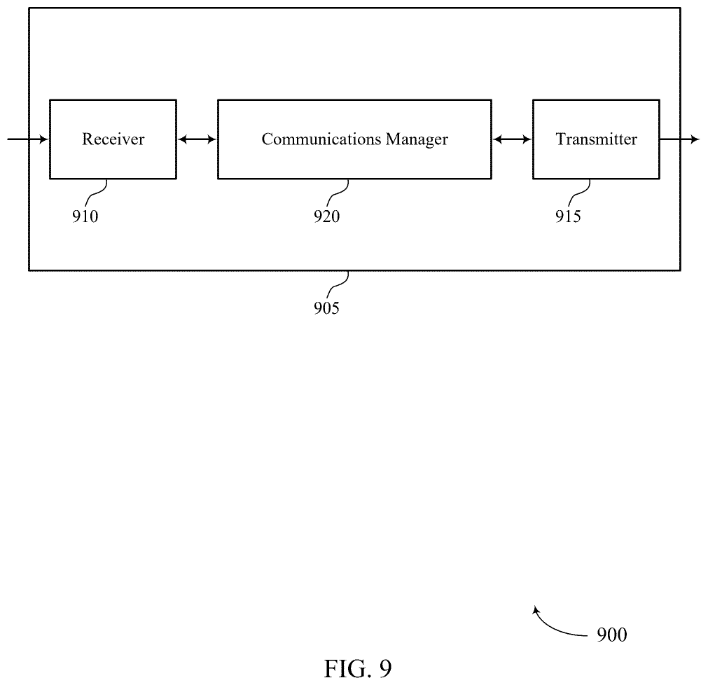

FIG. 9 shows a block diagram 900 of a device 905 that supports techniques for uplink resource muting at wireless devices in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for uplink resource muting at wireless devices as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving at least one capability message indicating that a UE supports uplink resource muting in accordance with one or more resource muting patterns, where each resource muting pattern of the one or more resource muting patterns is associated with a respective set of resource elements. The communications manager 920 is capable of, configured to, or operable to support a means for transmitting an indication for the UE to operate in accordance with a resource muting pattern of the one or more resource muting patterns based on transmission of the at least one capability message. The communications manager 920 is capable of, configured to, or operable to support a means for communicating, with the UE, in accordance with the resource muting pattern based on transmission of the indication.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, more efficient utilization of communication resources.

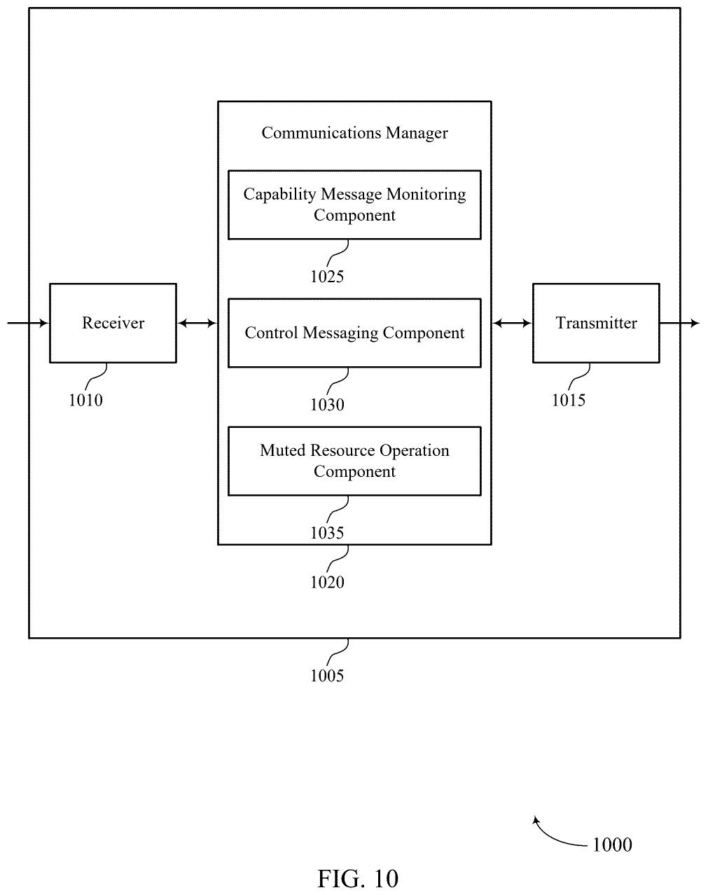

FIG. 10 shows a block diagram 1000 of a device 1005 that supports techniques for uplink resource muting at wireless devices in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for uplink resource muting at wireless devices as described herein. For example, the communications manager 1020 may include a capability message monitoring component 1025, a control messaging component 1030, a muted resource operation component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The capability message monitoring component 1025 is capable of, configured to, or operable to support a means for receiving at least one capability message indicating that a UE supports uplink resource muting in accordance with one or more resource muting patterns, where each resource muting pattern of the one or more resource muting patterns is associated with a respective set of resource elements. The control messaging component 1030 is capable of, configured to, or operable to support a means for transmitting an indication for the UE to operate in accordance with a resource muting pattern of the one or more resource muting patterns based on transmission of the at least one capability message. The muted resource operation component 1035 is capable of, configured to, or operable to support a means for communicating, with the UE, in accordance with the resource muting pattern based on transmission of the indication.

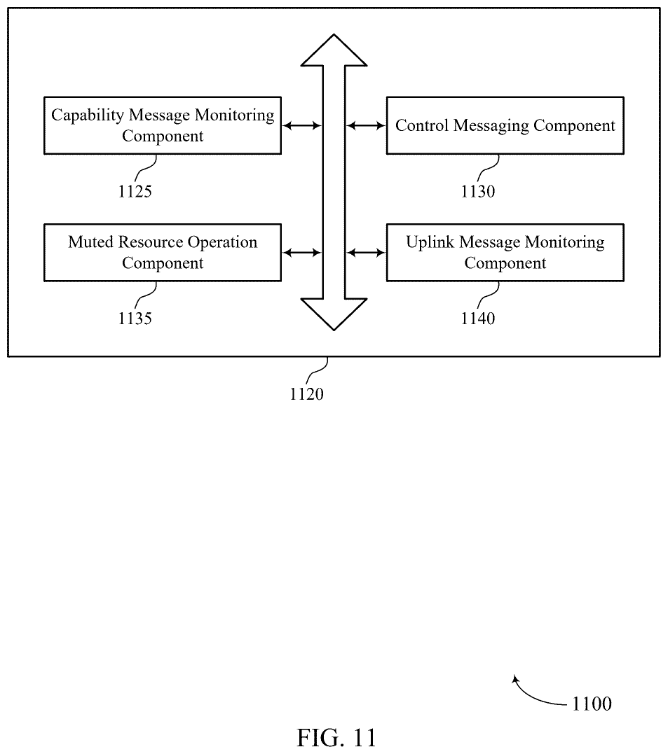

FIG. 11 shows a block diagram 1100 of a communications manager 1120 that supports techniques for uplink resource muting at wireless devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for uplink resource muting at wireless devices as described herein. For example, the communications manager 1120 may include a capability message monitoring component 1125, a control messaging component 1130, a muted resource operation component 1135, an uplink message monitoring component 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The capability message monitoring component 1125 is capable of, configured to, or operable to support a means for receiving at least one capability message indicating that a UE supports uplink resource muting in accordance with one or more resource muting patterns, where each resource muting pattern of the one or more resource muting patterns is associated with a respective set of resource elements. The control messaging component 1130 is capable of, configured to, or operable to support a means for transmitting an indication for the UE to operate in accordance with a resource muting pattern of the one or more resource muting patterns based on transmission of the at least one capability message. The muted resource operation component 1135 is capable of, configured to, or operable to support a means for communicating, with the UE, in accordance with the resource muting pattern based on transmission of the indication.

In some examples, the at least one capability message indicates that the uplink resource muting is supported by the UE in accordance with the one or more resource muting patterns on a per uplink waveform type basis.

In some examples, each resource muting pattern of the one or more resource muting patterns is rate matched in accordance with a set of muted resource elements corresponding to each resource muting pattern.

In some examples, the one or more resource muting patterns include at least one of a first resource muting pattern including a comb-2 SRS-like muting pattern; a second muting pattern including a zero power PTRS-like resource muting pattern or a sparse in frequency resource muting pattern; a third muting pattern including a comb-2 SRS-like muting pattern for DFT-S-OFDM, for cyclic prefix orthogonal frequency division multiplexing (CP-OFDM), or both; or a fourth muting pattern including a zero power PTRS-like resource muting pattern or a sparse in frequency resource muting pattern, the fourth muting pattern for DFT-S-OFDM, for CP-OFDM, or both.

In some examples, the capability message monitoring component 1125 is capable of, configured to, or operable to support a means for receiving, as part of the at least one capability message, an indication of a maximum quantity of uplink resource muting patterns supported by the UE, an indication of a respective maximum quantity of uplink resource muting patterns supported by the UE for each BWP of a set of BWPs, an indication of a respective maximum quantity of uplink resource muting patterns supported by the UE for each waveform of a set of waveforms, or a combination thereof.

In some examples, to support receiving the at least one capability message, the capability message monitoring component 1125 is capable of, configured to, or operable to support a means for receiving an indication that the UE supports the uplink resource muting for an RRC connected mode, for an RRC inactive mode, for an RRC idle mode, or a combination thereof.

In some examples, a first set of muted resource elements associated with the resource muting pattern at least partially overlaps with a second set of resource elements scheduled for a DMRS.

In some examples, to support communicating in accordance with the resource muting pattern, the uplink message monitoring component 1140 is capable of, configured to, or operable to support a means for receiving the DMRS and an associated uplink data message, where the UE refrains from muting the first set of muted resource elements based on the first set of muted resource elements at least partially overlapping with the second set of resource elements scheduled for the DMRS.

In some examples, to support communicating in accordance with the resource muting pattern, the uplink message monitoring component 1140 is capable of, configured to, or operable to support a means for receiving, via a subset of the second set of resource elements, the DMRS and an associated uplink data message, where the subset of the second set of resource elements include one or more resource elements that do not overlap with the first set of muted resource elements.

In some examples, network entity does not schedule a subset of the second set of resource elements that overlap with a subset of the first set of muted resource elements.

In some examples, network entity does not schedule a subset of the second set of resource elements that overlap in a same symbol with a subset of the first set of muted resource elements.

In some examples, network entity does not schedule a subset of the second set of resource elements that overlap in a same symbol and a same frequency carrier with a subset of the first set of muted resource elements.

In some examples, a first set of muted resource elements associated with the resource muting pattern at least partially overlaps with a second set of resource elements scheduled for a PTRS.

In some examples, to support communicating in accordance with the resource muting pattern, the uplink message monitoring component 1140 is capable of, configured to, or operable to support a means for receiving the PTRS, via a subset of the second set of resource elements, where the subset of the second set of resource elements include one or more resource elements that do not overlap with the first set of muted resource elements.

In some examples, to support communicating in accordance with the resource muting pattern, the uplink message monitoring component 1140 is capable of, configured to, or operable to support a means for receiving the PTRS, via the second set of resource elements, where the UE refrains from muting the first set of muted resource elements based on the first set of muted resource elements at least partially overlapping with the second set of resource elements scheduled for the PTRS.

In some examples, network entity does not schedule a subset of the second set of resource elements that overlap with a subset of the first set of muted resource elements.

In some examples, network entity does not schedule a subset of the second set of resource elements that overlap in a same OFDM symbol with a subset of the first set of muted resource elements.

In some examples, network entity does not schedule a subset of the second set of resource elements that overlap in a same symbol and a same frequency carrier with a subset of the first set of muted resource elements.

In some examples, a first set of muted resource elements associated with the resource muting pattern at least partially overlaps with a second set of resource elements scheduled for UCI.

In some examples, network entity does not schedule a subset of the second set of resource elements that overlap with a subset of the first set of muted resource elements.

In some examples, network entity does not schedule a subset of the second set of resource elements that overlap in a same OFDM symbol with a subset of the first set of muted resource elements.

In some examples, network entity does not schedule a subset of the second set of resource elements that overlap in a same symbol and a same frequency carrier with a subset of the first set of muted resource elements.

In some examples, the network entity does not schedule UCI that overlaps with an PUSCH in a same OFDM symbol based on the PUSCH being allocated with less than a threshold quantity of resource blocks, being allocated with less than a threshold quantity of symbols, or both.

In some examples, a first set of muted resource elements associated with the resource muting pattern at least partially overlaps with a second set of resource elements scheduled for an PUSCH message.

In some examples, the uplink message monitoring component 1140 is capable of, configured to, or operable to support a means for receiving the PUSCH message without the first set of muted resource elements being muted based at least in part on the PUSCH message being allocated with less than a threshold quantity of resource blocks, being allocated with less than a threshold quantity of symbols, or both.

In some examples, the control messaging component 1130 is capable of, configured to, or operable to support a means for transmitting a first control message that configures the UE with the one or more resource muting patterns. In some examples, the control messaging component 1130 is capable of, configured to, or operable to support a means for transmitting a second control message that includes one or more bits that indicates activation of the resource muting pattern, where the indication to operate in accordance with the resource muting pattern is based on the one or more bits.

In some examples, the first control message configures the UE with a single resource muting pattern; and the second control message includes a single bit, a first value of the single bit indicates the activation of the single resource muting pattern and a second value of the single bit indicates deactivation of the single resource muting pattern.

In some examples, the first control message configures the UE with a set of multiple resource muting patterns; and the second control message includes a set of multiple bits, a first value of the set of multiple bits indicates deactivation for each of the set of multiple resource muting patterns and one or more second values of the set of multiple bits respectively indicate activation of a respective resource muting pattern of the set of multiple resource muting patterns.

In some examples, the second control message is a MAC-CE message.

In some examples, the second control message is a GC-DCI message.

In some examples, the second control message is a dynamic DCI message and the one or more bits are included in a field of the dynamic DCI message.

In some examples, the respective set of resource elements are at least in part associated with a CLI measurement. In some examples, uplink transmissions on the respective set of resource elements are muted during the CLI measurement.

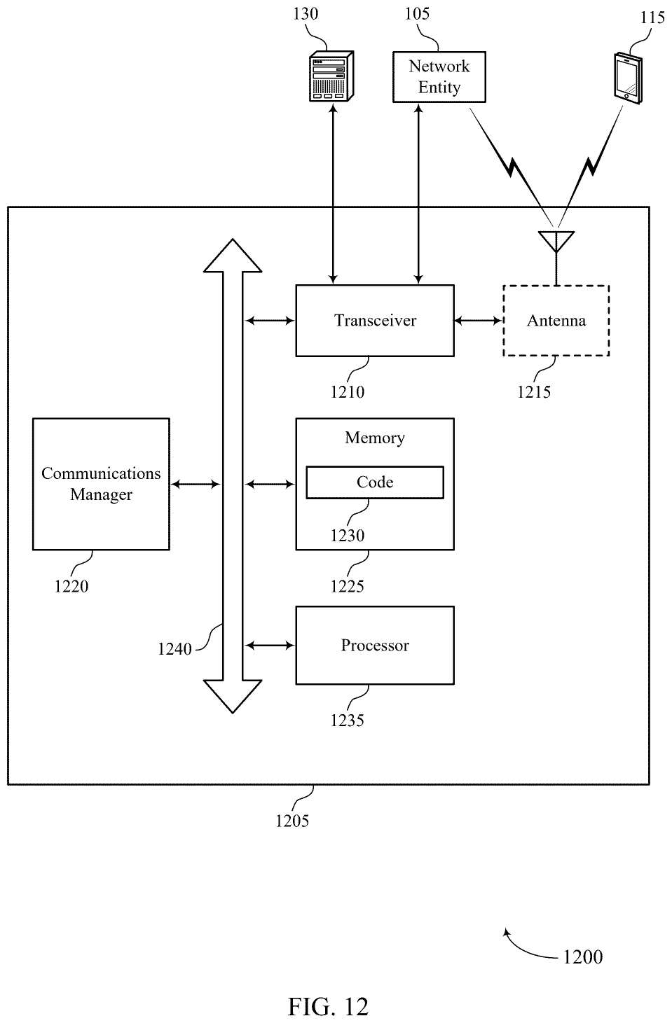

FIG. 12 shows a diagram of a system 1200 including a device 1205 that supports techniques for uplink resource muting at wireless devices in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for uplink resource muting at wireless devices). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving at least one capability message indicating that a UE supports uplink resource muting in accordance with one or more resource muting patterns, where each resource muting pattern of the one or more resource muting patterns is associated with a respective set of resource elements. The communications manager 1220 is capable of, configured to, or operable to support a means for transmitting an indication for the UE to operate in accordance with a resource muting pattern of the one or more resource muting patterns based on transmission of the at least one capability message. The communications manager 1220 is capable of, configured to, or operable to support a means for communicating, with the UE, in accordance with the resource muting pattern based on transmission of the indication.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for uplink resource muting at wireless devices as described herein, or the at least one processor 1235 and the at least one memory 1225 may be otherwise configured to, individually or collectively, perform or support such operations.

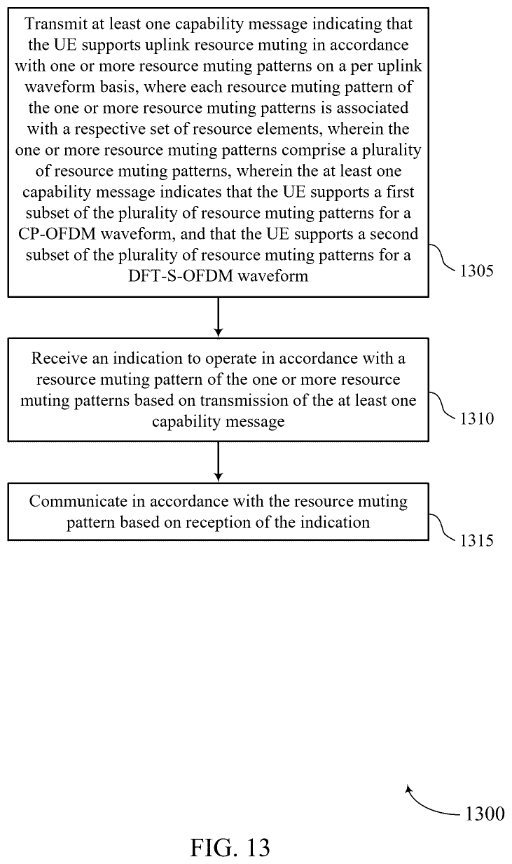

FIG. 13 shows a flowchart illustrating a method 1300 that supports techniques for uplink resource muting at wireless devices in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting at least one capability message indicating that the UE supports uplink resource muting in accordance with one or more resource muting patterns on a per uplink waveform basis, where each resource muting pattern of the one or more resource muting patterns is associated with a respective set of resource elements, wherein the one or more resource muting patterns comprise a plurality of resource muting patterns, wherein the at least one capability message indicates that the UE supports a first subset of the plurality of resource muting patterns for a CP-OFDM waveform, and that the UE supports a second subset of the plurality of resource muting patterns for a DFT-S-OFDM waveform. The operations of 1305 may be performed in accordance with examples as disclosed herein. In some examples, aspects of the operations of 1305 may be performed by a capability messaging component 725 as described with reference to FIG. 7.

At 1310, the method may include receiving an indication to operate in accordance with a resource muting pattern of the one or more resource muting patterns based on transmission of the at least one capability message. The operations of 1310 may be performed in accordance with examples as disclosed herein. In some examples, aspects of the operations of 1310 may be performed by a control message monitoring component 730 as described with reference to FIG. 7.

At 1315, the method may include communicating in accordance with the resource muting pattern based on reception of the indication. The operations of 1315 may be performed in accordance with examples as disclosed herein. In some examples, aspects of the operations of 1315 may be performed by a muted resource operation component 735 as described with reference to FIG. 7.

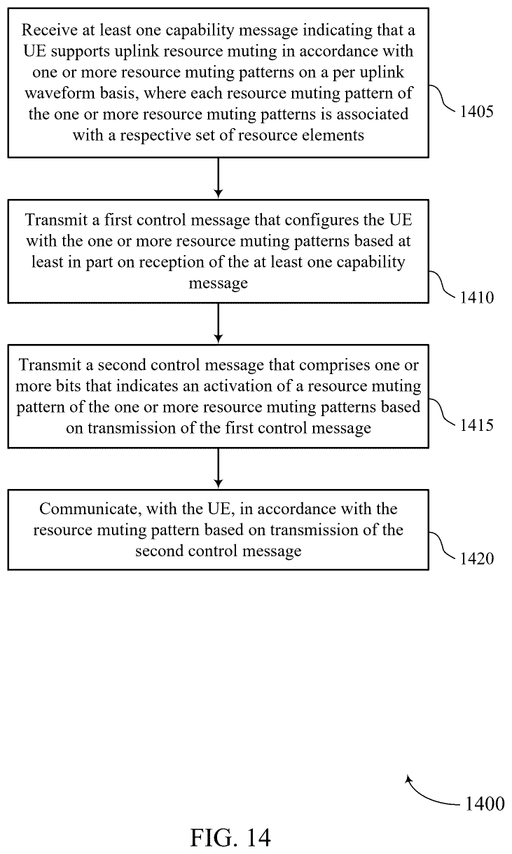

FIG. 14 shows a flowchart illustrating a method 1400 that supports techniques for uplink resource muting at wireless devices in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include receiving at least one capability message indicating that a UE supports uplink resource muting in accordance with one or more resource muting patterns on a per uplink waveform basis, where each resource muting pattern of the one or more resource muting patterns is associated with a respective set of resource elements. The operations of 1405 may be performed in accordance with examples as disclosed herein. In some examples, aspects of the operations of 1405 may be performed by a capability message monitoring component 1125 as described with reference to FIG. 11.

At 1410, the method may include transmitting a first control message that configures the UE with the one or more resource muting patterns based on reception of the at least one capability message. The operations of 1410 may be performed in accordance with examples as disclosed herein.

At 1415, the method may include transmitting a second control message that comprises one or more bits that indicates an activation a resource muting pattern of the one or more resource muting patterns based on transmission of the first control message. The operations of 1415 may be performed in accordance with examples as disclosed herein. In some examples, aspects of the operations of 1415 may be performed by a control messaging component 1130 as described with reference to FIG. 11.

At 1420, the method may include communicating, with the UE, in accordance with the resource muting pattern based on transmission of the second control message. The operations of 1420 may be performed in accordance with examples as disclosed herein. In some examples, aspects of the operations of 1420 may be performed by a muted resource operation component 1135 as described with reference to FIG. 11.

The following provides an overview of aspects of the present disclosure:

Aspect 1: A method for wireless communications, at a UE, comprising: transmitting at least one capability message indicating that the UE supports uplink resource muting in accordance with one or more resource muting patterns, wherein each resource muting pattern of the one or more resource muting patterns is associated with a respective set of resource elements; receiving an indication to operate in accordance with a resource muting pattern of the one or more resource muting patterns based at least in part on transmission of the at least one capability message; and communicating in accordance with the resource muting pattern based at least in part on reception of the indication.

Aspect 2: The method of aspect 1, wherein the at least one capability message indicates that the uplink resource muting is supported by the UE in accordance with the one or more resource muting patterns on a per uplink waveform type basis. By enabling the UE 115-a to indicate which respective uplink resource muting patterns are supported for each respective uplink waveform type, aspects of the present disclosure may enable improved coordination between the UE 115-a and the network by enabling the network to “know” which uplink muting patterns to expect or schedule for respective uplink waveforms, which may lead to more efficient and reliable wireless communications.

Aspect 3: The method of any of aspects 1 through 2, wherein each resource muting pattern of the one or more resource muting patterns is rate matched in accordance with a set of muted resource elements corresponding to each resource muting pattern.

Aspect 4: The method of any of aspects 1 through 3, wherein the one or more resource muting patterns comprise at least one of a first resource muting pattern based at least in part on a comb-2 SRS muting pattern; a second muting pattern based at least in part on a zero power PTRS resource muting pattern or a sparse in frequency resource muting pattern; a third muting pattern based at least in part on a comb-2 SRS muting pattern for DFT-S-OFDM, for CP-OFDM, or both; or a fourth muting pattern based at least in part on a zero power PTRS resource muting pattern or a sparse in frequency resource muting pattern, the fourth muting pattern for DFT-S-OFDM, for CP-OFDM, or both.

Aspect 5: The method of any of aspects 1 through 4, further comprising: transmitting, as part of the at least one capability message, an indication of a maximum quantity of uplink resource muting patterns supported by the UE, an indication of a respective maximum quantity of uplink resource muting patterns supported by the UE for each BWP of a set of BWPs, an indication of a respective maximum quantity of uplink resource muting patterns supported by the UE for each waveform of a set of waveforms, or a combination thereof.

Aspect 6: The method of any of aspects 1 through 5, wherein transmitting the at least one capability message comprises: transmitting an indication that the UE supports the uplink resource muting for an RRC connected mode, for an RRC inactive mode, for an RRC idle mode, or a combination thereof.

Aspect 7: The method of any of aspects 1 through 6, wherein communicating in accordance with the resource muting pattern is further based at least in part on one or more symbols being SBFD symbols or full duplex symbols.

Aspect 8: The method of any of aspects 1 through 7, wherein a first set of muted resource elements associated with the resource muting pattern at least partially overlaps with a second set of resource elements scheduled for a DMRS.

Aspect 9: The method of aspect 8, wherein communicating in accordance with the resource muting pattern comprises: dropping the DMRS based at least in part on the first set of muted resource elements at least partially overlapping with the second set of resource elements scheduled for the DMRS; and muting the first set of muted resource elements based at least in part on dropping the DMRS.

Aspect 10: The method of any of aspects 8 through 9, wherein communicating in accordance with the resource muting pattern comprises: transmitting the DMRS and an associated uplink data message, wherein the UE refrains from muting the first set of muted resource elements based at least in part on the first set of muted resource elements at least partially overlapping with the second set of resource elements scheduled for the DMRS.

Aspect 11: The method of any of aspects 8 through 10, wherein communicating in accordance with the resource muting pattern comprises: transmitting, via a subset of the second set of resource elements, the DMRS and an associated uplink data message, wherein the subset of the second set of resource elements comprises one or more resource elements that do not overlap with the first set of muted resource elements; and muting a subset of the first set of muted resource elements that do not overlap with the second set of resource elements. Each of these DMRS collision resolution protocols provide specific rules or conditions that define how the UE is to behave with respect to muted resource elements and DMRSs, and thereby provide improved coordination between the UE and the network. Therefore, the DMRS collision resolution protocols, when agreed upon between the UE and the network, enable the UE and the network to share an understanding with respect to which communications will be performed to achieve improved reliability and fewer retransmissions.

Aspect 12: The method of any of aspects 8 through 11, wherein the UE determines an error case based at least in part on a subset of the second set of resource elements overlapping in a same symbol with a subset of the first set of muted resource elements.

Aspect 13: The method of any of aspects 8 through 12, wherein the UE determines an error case based at least in part on a subset of the second set of resource elements overlapping in a same symbol and a same frequency carrier with a subset of the first set of muted resource elements.

Aspect 14: The method of any of aspects 1 through 13, further comprising: determining, as part of a transport block size calculation, a quantity of resource blocks associated with a CLI measurement, wherein the quantity of resource blocks is equal to an allocated quantity of resource blocks scheduled during the CLI measurement.

Aspect 15: The method of any of aspects 1 through 14, further comprising: determining, as part of a transport block size calculation, a quantity of resource blocks associated with a CLI measurement, wherein the quantity of resource blocks is equal to an allocated quantity of resource blocks scheduled during the CLI measurement that do not overlap with a first set of muted resource elements.

Aspect 16: The method of any of aspects 1 through 15, wherein a first set of muted resource elements associated with the resource muting pattern at least partially overlaps with a second set of resource elements scheduled for a PTRS.

Aspect 17: The method of aspect 16, wherein communicating in accordance with the resource muting pattern comprises: transmitting the PTRS via a subset of the second set of resource elements, wherein the subset of the second set of resource elements comprises one or more resource elements that do not overlap with the first set of muted resource elements; and muting a subset of the first set of muted resource elements that do not overlap with the second set of resource elements.

Aspect 18: The method of any of aspects 16 through 17, wherein communicating in accordance with the resource muting pattern comprises: transmitting the PTRS via the second set of resource elements, wherein the UE refrains from muting the first set of muted resource elements based at least in part on the first set of muted resource elements at least partially overlapping with the second set of resource elements scheduled for the PTRS. Each of these PTRS collision resolution protocols provide specific rules or conditions that define how the UE is to behave with respect to muted resource elements and PTRSs, and thereby provide improved coordination between the UE and the network. Therefore, the PTRS collision resolution protocols, when agreed upon between the UE and the network, enable the UE and the network to share an understanding with respect to which communications will be performed to achieve improved reliability and fewer retransmissions.

Aspect 19: The method of any of aspects 16 through 18, wherein the UE determines an error case based at least in part on a subset of the second set of resource elements overlapping in a same symbol with a subset of the first set of muted resource elements.

Aspect 20: The method of any of aspects 16 through 19, wherein the UE determines an error case based at least in part on a subset of the second set of resource elements overlapping in a same symbol and a same frequency carrier with a subset of the first set of muted resource elements.

Aspect 21: The method of any of aspects 1 through 20, wherein a first set of muted resource elements associated with the resource muting pattern at least partially overlaps with a second set of resource elements scheduled for UCI.

Aspect 22: The method of aspect 21, wherein the UE determines an error case based at least in part on a subset of the second set of resource elements overlapping in a same OFDM symbol with a subset of the first set of muted resource elements.

Aspect 23: The method of any of aspects 21 through 22, wherein the UE determines an error case based at least in part on a subset of the second set of resource elements that overlap in a same symbol and a same frequency carrier with a subset of the first set of muted resource elements.

Aspect 24: The method of any of aspects 1 through 23, wherein the UE determines an error case in accordance with UCI overlapping with an PUSCH in a same OFDM symbol based at least in part on the PUSCH being allocated with less than a threshold quantity of resource blocks, being allocated with less than a threshold quantity of symbols, or both. Each of these UCI collision resolution protocols provide specific rules or conditions that define how the UE is to behave with respect to muted resource elements and UCI, and thereby provide improved coordination between the UE and the network. Therefore, the UCI collision resolution protocols, when agreed upon between the UE and the network, enable the UE and the network to share an understanding with respect to which communications will be performed to achieve improved reliability and fewer retransmissions.

Aspect 25: The method of any of aspects 1 through 24, wherein a first set of muted resource elements associated with the resource muting pattern at least partially overlaps with a second set of resource elements scheduled for an PUSCH message.

Aspect 26: The method of aspect 25, further comprising: transmitting the PUSCH message based at least in part on the PUSCH message being allocated with less than a threshold quantity of resource blocks, being allocated with less than a threshold quantity of symbols, or both, wherein the UE refrains from muting the first set of muted resource elements. By transmitting the PUSCH transmission (instead of transmitting the first set of muted resource elements), throughput between the UE and the network entity may be increased.

Aspect 27: The method of any of aspects 1 through 26, further comprising: receiving a first control message that configures the UE with the one or more resource muting patterns; and receiving a second control message that comprises one or more bits that indicates activation or deactivation of the resource muting pattern, wherein the indication to operate in accordance with the resource muting pattern is based at least in part on the one or more bits.

Aspect 28: The method of aspect 27, wherein the first control message configures the UE with a plurality of resource muting patterns; and the second control message comprises a plurality of bits, a first value of the plurality of bits indicates deactivation for each of the plurality of resource muting patterns and one or more second values of the plurality of bits respectively indicate activation of a respective resource muting pattern of the plurality of resource muting patterns.

Aspect 29: The method of any of aspects 27 through 28, wherein the second control message is a MAC-CE message.

Aspect 30: The method of any of aspects 27 through 29, wherein the second control message is a GC-DCI message.

Aspect 31: The method of any of aspects 27 through 30, wherein the second control message is a DCI message and the one or more bits are comprised in a field of the DCI message.

Aspect 32: The method of any of aspects 1 through 31, wherein the respective set of resource elements are at least in part associated with a CLI measurement, and uplink transmissions on the respective set of resource elements are muted during the CLI measurement.

Aspect 33: A method for wireless communications, at a network entity, comprising: receiving at least one capability message indicating that a UE supports uplink resource muting in accordance with one or more resource muting patterns, wherein each resource muting pattern of the one or more resource muting patterns is associated with a respective set of resource elements; transmitting an indication for the UE to operate in accordance with a resource muting pattern of the one or more resource muting patterns based at least in part on transmission of the at least one capability message; and communicating, with the UE, in accordance with the resource muting pattern based at least in part on transmission of the indication.

Aspect 34: The method of aspect 33, wherein the at least one capability message indicates that the uplink resource muting is supported by the UE in accordance with the one or more resource muting patterns on a per uplink waveform type basis.

Aspect 35: The method of any of aspects 33 through 34, wherein each resource muting pattern of the one or more resource muting patterns is rate matched in accordance with a set of muted resource elements corresponding to each resource muting pattern.

Aspect 36: The method of any of aspects 33 through 35, wherein the one or more resource muting patterns comprise at least one of a first resource muting pattern based at least in part on a comb-2 SRS muting pattern; a second muting pattern based at least in part on a zero power PTRS resource muting pattern or a sparse in frequency resource muting pattern; a third muting pattern based at least in part on a comb-2 SRS muting pattern for DFT-S-OFDM, for CP-OFDM, or both; or a fourth muting pattern based at least in part on a zero power PTRS resource muting pattern or a sparse in frequency resource muting pattern, the fourth muting pattern for DFT-S-OFDM, for CP-OFDM, or both.

Aspect 37: The method of any of aspects 33 through 36, further comprising: receiving, as part of the at least one capability message, an indication of a maximum quantity of uplink resource muting patterns supported by the UE, an indication of a respective maximum quantity of uplink resource muting patterns supported by the UE for each BWP of a set of BWPs, an indication of a respective maximum quantity of uplink resource muting patterns supported by the UE for each waveform of a set of waveforms, or a combination thereof.

Aspect 38: The method of any of aspects 33 through 37, wherein receiving the at least one capability message comprises: receiving an indication that the UE supports the uplink resource muting for an RRC connected mode, for an RRC inactive mode, for an RRC idle mode, or a combination thereof.

Aspect 39: The method of any of aspects 33 through 38, wherein a first set of muted resource elements associated with the resource muting pattern at least partially overlaps with a second set of resource elements scheduled for a DMRS.

Aspect 40: The method of aspect 39, wherein communicating in accordance with the resource muting pattern comprises: receiving the DMRS and an associated uplink data message, wherein the UE refrains from muting the first set of muted resource elements based at least in part on the first set of muted resource elements at least partially overlapping with the second set of resource elements scheduled for the DMRS.

Aspect 41: The method of any of aspects 39 through 40, wherein communicating in accordance with the resource muting pattern comprises: receiving, via a subset of the second set of resource elements, the DMRS and an associated uplink data message, wherein the subset of the second set of resource elements comprise one or more resource elements that do not overlap with the first set of muted resource elements.

Aspect 42: The method of any of aspects 39 through 41, wherein network entity does not schedule a subset of the second set of resource elements that overlap with a subset of the first set of muted resource elements.

Aspect 43: The method of any of aspects 39 through 42, wherein network entity does not schedule a subset of the second set of resource elements that overlap in a same symbol with a subset of the first set of muted resource elements.

Aspect 44: The method of any of aspects 39 through 43, wherein network entity does not schedule a subset of the second set of resource elements that overlap in a same symbol and a same frequency carrier with a subset of the first set of muted resource elements.

Aspect 45: The method of any of aspects 33 through 44, wherein a first set of muted resource elements associated with the resource muting pattern at least partially overlaps with a second set of resource elements scheduled for a PTRS.

Aspect 46: The method of aspect 45, wherein communicating in accordance with the resource muting pattern comprises: receiving the PTRS, via a subset of the second set of resource elements, wherein the subset of the second set of resource elements comprise one or more resource elements that do not overlap with the first set of muted resource elements.

Aspect 47: The method of any of aspects 45 through 46, wherein communicating in accordance with the resource muting pattern comprises: receiving the PTRS, via the second set of resource elements, wherein the UE refrains from muting the first set of muted resource elements based at least in part on the first set of muted resource elements at least partially overlapping with the second set of resource elements scheduled for the PTRS.

Aspect 48: The method of any of aspects 45 through 47, wherein network entity does not schedule a subset of the second set of resource elements that overlap with a subset of the first set of muted resource elements.

Aspect 49: The method of any of aspects 45 through 48, wherein network entity does not schedule a subset of the second set of resource elements that overlap in a same OFDM symbol with a subset of the first set of muted resource elements.

Aspect 50: The method of any of aspects 45 through 49, wherein network entity does not schedule a subset of the second set of resource elements that overlap in a same symbol and a same frequency carrier with a subset of the first set of muted resource elements.

Aspect 51: The method of any of aspects 33 through 50, wherein a first set of muted resource elements associated with the resource muting pattern at least partially overlaps with a second set of resource elements scheduled for UCI.

Aspect 52: The method of aspect 51, wherein network entity does not schedule a subset of the second set of resource elements that overlap with a subset of the first set of muted resource elements.

Aspect 53: The method of any of aspects 51 through 52, wherein network entity does not schedule a subset of the second set of resource elements that overlap in a same OFDM symbol with a subset of the first set of muted resource elements.

Aspect 54: The method of any of aspects 51 through 53, wherein network entity does not schedule a subset of the second set of resource elements that overlap in a same symbol and a same frequency carrier with a subset of the first set of muted resource elements.

Aspect 55: The method of any of aspects 33 through 54, wherein the network entity does not schedule UCI that overlaps with an PUSCH in a same OFDM symbol based at least in part on the PUSCH being allocated with less than a threshold quantity of resource blocks, being allocated with less than a threshold quantity of symbols, or both.

Aspect 56: The method of any of aspects 33 through 55, wherein a first set of muted resource elements associated with the resource muting pattern at least partially overlaps with a second set of resource elements scheduled for an PUSCH message.

Aspect 57: The method of aspect 56, further comprising: receiving the PUSCH message without the first set of muted resource elements being muted based at least in part on the PUSCH message being allocated with less than a threshold quantity of resource blocks, being allocated with less than a threshold quantity of symbols, or both.

Aspect 58: The method of any of aspects 33 through 57, further comprising: transmitting a first control message that configures the UE with the one or more resource muting patterns; and transmitting a second control message that comprises one or more bits that indicates activation of the resource muting pattern, wherein the indication to operate in accordance with the resource muting pattern is based at least in part on the one or more bits.

Aspect 59: The method of aspect 58, wherein the first control message configures the UE with a single resource muting pattern; and the second control message comprises a single bit, a first value of the single bit indicates the activation of the single resource muting pattern and a second value of the single bit indicates deactivation of the single resource muting pattern.

Aspect 60: The method of any of aspects 58 through 59, wherein the first control message configures the UE with a plurality of resource muting patterns; and the second control message comprises a plurality of bits, a first value of the plurality of bits indicates deactivation for each of the plurality of resource muting patterns and one or more second values of the plurality of bits respectively indicate activation of a respective resource muting pattern of the plurality of resource muting patterns.

Aspect 61: The method of any of aspects 58 through 60, wherein the second control message is a MAC-CE message.

Aspect 62: The method of any of aspects 58 through 61, wherein the second control message is a GC-DCI message.

Aspect 63: The method of any of aspects 58 through 62, wherein the second control message is a dynamic DCI message and the one or more bits are comprised in a field of the dynamic DCI message.

Aspect 64: The method of any of aspects 33 through 63, wherein the respective set of resource elements are at least in part associated with a CLI measurement, and uplink transmissions on the respective set of resource elements are muted during the CLI measurement.

Aspect 65: A UE for wireless communications, comprising one or more memories storing processor-executable code, and one or more processors coupled with the one or more memories and individually or collectively operable to execute the code to cause the UE to perform a method of any of aspects 1 through 32.

Aspect 66: A UE for wireless communications, comprising at least one means for performing a method of any of aspects 1 through 32.

Aspect 67: A non-transitory computer-readable medium storing code for wireless communications, the code comprising instructions executable by one or more processors to perform a method of any of aspects 1 through 32.

Aspect 68: A network entity for wireless communications, comprising one or more memories storing processor-executable code, and one or more processors coupled with the one or more memories and individually or collectively operable to execute the code to cause the network entity to perform a method of any of aspects 33 through 64.

Aspect 69: A network entity for wireless communications, comprising at least one means for performing a method of any of aspects 33 through 64.

Aspect 70: A non-transitory computer-readable medium storing code for wireless communications, the code comprising instructions executable by one or more processors to perform a method of any of aspects 33 through 64.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit at least one capability message indicating that the UE supports uplink resource muting in accordance with one or more resource muting patterns on a per uplink waveform basis, wherein each resource muting pattern of the one or more resource muting patterns is associated with a respective set of resource elements;
receive an indication to operate in accordance with a resource muting pattern of the one or more resource muting patterns based at least in part on transmission of the at least one capability message; and
communicate in accordance with the resource muting pattern based at least in part on reception of the indication.

2. The UE of claim 1, wherein the at least one capability message indicates that the UE supports the one or more resource muting patterns for a cyclic prefix orthogonal frequency division multiplexing (CP-OFDM) waveform, a discrete Fourier Transform-spread OFDM (DFT-S-OFDM) waveform, or both.

3. The UE of claim 2, wherein the one or more resource muting patterns comprise a plurality of resource muting patterns, wherein the at least one capability message indicates that the UE supports a first subset of the plurality of resource muting patterns for the CP-OFDM waveform, and that the UE supports a second subset of the plurality of resource muting patterns for the DFT-S-OFDM waveform.

4. The UE of claim 1, wherein communicating in accordance with the resource muting pattern is further based at least in part on one or more symbols being subband full duplex (SBFD) symbols or full duplex symbols.

5. The UE of claim 1, wherein the one or more processors are individually or collectively further operable to execute the code to cause the UE to:
receive a first control message that configures the UE with the one or more resource muting patterns; and
receive a second control message that comprises one or more bits that indicates activation or deactivation of the resource muting pattern, wherein the indication to operate in accordance with the resource muting pattern is based at least in part on the one or more bits.

6. The UE of claim 5, wherein:
the first control message configures the UE with a plurality of resource muting patterns; and
the second control message comprises a plurality of bits, a first value of the plurality of bits indicates deactivation for each of the plurality of resource muting patterns and one or more second values of the plurality of bits respectively indicate activation of a respective resource muting pattern of the plurality of resource muting patterns.

7. The UE of claim 5, wherein the second control message is a downlink control information (DCI) message and the one or more bits are comprised in a field of the DCI message.

8. The UE of claim 5, wherein the second control message is a medium access control-control element (MAC-CE) message or a group-common downlink control information (GC-DCI) message.

9. The UE of claim 1, wherein each resource muting pattern of the one or more resource muting patterns is rate matched in accordance with a set of muted resource elements corresponding to each resource muting pattern.

10. The UE of claim 1, wherein the one or more resource muting patterns comprise at least one of:
a first resource muting pattern based at least in part on a comb-2 sounding reference signal (SRS) muting pattern;
a second muting pattern based at least in part on a zero power phase tracking reference signal (PTRS) resource muting pattern or a sparse in frequency resource muting pattern;
a third muting pattern based at least in part on a comb-2 SRS muting pattern for discrete Fourier Transform-spread orthogonal frequency division multiplexing (DFT-S-OFDM), for cyclic prefix orthogonal frequency division multiplexing (CP-OFDM), or both; or
a fourth muting pattern based at least in part on a zero power PTRS resource muting pattern or a sparse in frequency resource muting pattern, the fourth muting pattern for DFT-S-OFDM, for CP-OFDM, or both.

11. The UE of claim 1, wherein the one or more processors are individually or collectively further operable to execute the code to cause the UE to:
transmit, as part of the at least one capability message, an indication of a maximum quantity of uplink resource muting patterns supported by the UE, an indication of a respective maximum quantity of uplink resource muting patterns supported by the UE for each bandwidth part of a set of bandwidth parts, an indication of a respective maximum quantity of uplink resource muting patterns supported by the UE for each waveform of a set of waveforms, or a combination thereof.

12. The UE of claim 1, wherein, to transmit the at least one capability message, the one or more processors are individually or collectively operable to execute the code to cause the UE to:
transmit an indication that the UE supports the uplink resource muting for a radio resource control (RRC) connected mode, for an RRC inactive mode, for an RRC idle mode, or a combination thereof.

13. The UE of claim 1, wherein a first set of muted resource elements associated with the resource muting pattern at least partially overlaps with a second set of resource elements scheduled for a demodulated reference signal (DMRS).

14. The UE of claim 13, wherein, to communicate in accordance with the resource muting pattern, the one or more processors are individually or collectively operable to execute the code to cause the UE to:
transmit the DMRS and an associated uplink data message, wherein the UE refrains from muting the first set of muted resource elements based at least in part on the first set of muted resource elements at least partially overlapping with the second set of resource elements scheduled for the DMRS.

15. The UE of claim 13, wherein, to communicate in accordance with the resource muting pattern, the one or more processors are individually or collectively operable to execute the code to cause the UE to:
drop the DMRS based at least in part on the first set of muted resource elements at least partially overlapping with the second set of resource elements scheduled for the DMRS; and
mute the first set of muted resource elements based at least in part on dropping the DMRS.

16. The UE of claim 13, wherein, to communicate in accordance with the resource muting pattern, the one or more processors are individually or collectively operable to execute the code to cause the UE to:
transmit, via a subset of the second set of resource elements, the DMRS and an associated uplink data message, wherein the subset of the second set of resource elements comprises one or more resource elements that do not overlap with the first set of muted resource elements; and
mute a subset of the first set of muted resource elements that do not overlap with the second set of resource elements.

17. The UE of claim 13, wherein the UE determines an error case based at least in part on a subset of the second set of resource elements overlapping in a same symbol, a same frequency carrier, or both, with a subset of the first set of muted resource elements.

18. The UE of claim 1, wherein the one or more processors are individually or collectively further operable to execute the code to cause the UE to:
determine, as part of a transport block size calculation, a quantity of resource blocks associated with a cross-link interference measurement, wherein the quantity of resource blocks is equal to an allocated quantity of resource blocks scheduled during the cross-link interference measurement.

19. The UE of claim 1, wherein a first set of muted resource elements associated with the resource muting pattern at least partially overlaps with a second set of resource elements scheduled for a phase tracking reference signal (PTRS).

20. The UE of claim 19, wherein, to communicate in accordance with the resource muting pattern, the one or more processors are individually or collectively operable to execute the code to cause the UE to:
transmit the PTRS via a subset of the second set of resource elements, wherein the subset of the second set of resource elements comprises one or more resource elements that do not overlap with the first set of muted resource elements; and
mute a subset of the first set of muted resource elements that do not overlap with the second set of resource elements.

21. The UE of claim 19, wherein, to communicate in accordance with the resource muting pattern, the one or more processors are individually or collectively operable to execute the code to cause the UE to:
transmit the PTRS via the second set of resource elements, wherein the UE refrains from muting the first set of muted resource elements based at least in part on the first set of muted resource elements at least partially overlapping with the second set of resource elements scheduled for the PTRS.

22. The UE of claim 19, wherein the UE determines an error case based at least in part on a subset of the second set of resource elements overlapping in a same symbol, a same frequency carrier, or both, with a subset of the first set of muted resource elements.

23. The UE of claim 1, wherein a first set of muted resource elements associated with the resource muting pattern at least partially overlaps with a second set of resource elements scheduled for uplink control information (UCI).

24. The UE of claim 23, wherein the UE determines an error case based at least in part on:
a subset of the second set of resource elements overlapping in a same orthogonal frequency-division multiplexing (OFDM) symbol with a subset of the first set of muted resource elements, or
the subset of the second set of resource elements overlapping in a same symbol and a same frequency carrier with the subset of the first set of muted resource elements.

25. The UE of claim 1, wherein the UE determines an error case in accordance with uplink control information (UCI) overlapping with a physical uplink shared channel (PUSCH) in a same orthogonal frequency-division multiplexing (OFDM) symbol based at least in part on the PUSCH being allocated with less than a threshold quantity of resource blocks, being allocated with less than a threshold quantity of symbols, or both.

26. The UE of claim 1, wherein a first set of muted resource elements associated with the resource muting pattern at least partially overlaps with a second set of resource elements scheduled for a physical uplink shared channel (PUSCH) message.

27. The UE of claim 26, wherein the one or more processors are individually or collectively further operable to execute the code to cause the UE to:
transmit the PUSCH message based at least in part on the PUSCH message being allocated with less than a threshold quantity of resource blocks, being allocated with less than a threshold quantity of symbols, or both, wherein the UE refrains from muting the first set of muted resource elements.

28. A method for wireless communications, at a user equipment (UE), comprising:
transmitting at least one capability message indicating that the UE supports uplink resource muting in accordance with one or more resource muting patterns on a per uplink waveform basis, wherein each resource muting pattern of the one or more resource muting patterns is associated with a respective set of resource elements;
receiving an indication to operate in accordance with a resource muting pattern of the one or more resource muting patterns based at least in part on transmission of the at least one capability message; and
communicating in accordance with the resource muting pattern based at least in part on reception of the indication.

29. A user equipment (UE) for wireless communications, comprising:
means for transmitting at least one capability message indicating that the UE supports uplink resource muting in accordance with one or more resource muting patterns on a per uplink waveform basis, wherein each resource muting pattern of the one or more resource muting patterns is associated with a respective set of resource elements;
means for receiving an indication to operate in accordance with a resource muting pattern of the one or more resource muting patterns based at least in part on transmission of the at least one capability message; and
means for communicating in accordance with the resource muting pattern based at least in part on reception of the indication.

30. A non-transitory computer-readable medium storing code for wireless communications, the code comprising instructions executable by one or more processors to:
transmit at least one capability message indicating that the UE supports uplink resource muting in accordance with one or more resource muting patterns on a per uplink waveform basis, wherein each resource muting pattern of the one or more resource muting patterns is associated with a respective set of resource elements;
receive an indication to operate in accordance with a resource muting pattern of the one or more resource muting patterns based at least in part on transmission of the at least one capability message; and
communicate in accordance with the resource muting pattern based at least in part on reception of the indication.
